(19) United States
(12) Patent Application Publication
(10) Pub. No.: US 2020/0151797 A1
(43) Pub. Date: May 14, 2020

(54) SYSTEM AND METHOD FOR BROWSER SCREEN SHARING WITH PEER ASSISTED ELECTRONIC COMMERCE

(71) Applicant: MUSYFY INC., Mississauga (CA)

(72) Inventor: Sarbjit S. PARHAR, Mississauga (CA)

(21) Appl. No.: 16/682,619

(22) Filed: Nov. 13, 2019

Related U.S. Application Data
(60) Provisional application No. 62/760,571, filed on Nov. 13, 2018.

(51) Int. Cl. G06Q 30/06; H04L 29/08; H04L 29/06; G06Q 50/00

(52) U.S. Cl. CPC G06Q 30/0631; H04L 67/20; G06Q 50/01; H04L 65/4023; H04L 67/306; H04L 67/02

(57) ABSTRACT

Systems and methods for browser screen sharing peer assisted electronic commerce are disclosed. An exemplary system for social shopping comprises a backend configured for: receiving, from a front end within a first web browser application of a first device, a selection of a product from a third-party webpage originated from a third-party host server; generating, at the backend, a message with respect to the product; sending, from the back end, the message to a second device; receiving, from the second device, a response to the message; and transmitting the response from the second device to the front end for displaying and enabling a person to make a purchase decision with respect to the product.

### CROSS-REFERENCE TO RELATED APPLICATION

This application claims priority from United States Provisional Patent Application No. 62/760,571, filed Nov. 13, 2018, entitled SYSTEM AND METHOD FOR BROWSER SCREEN SHARING WITH PEER ASSISTED ELECTRONIC COMMERCE, the contents of which are incorporated by reference into the DETAILED DESCRIPTION OF EXAMPLE EMBODIMENTS herein below.

### TECHNICAL FIELD

Some example embodiments relate to browser screen sharing with peer assisted electronic commerce and social shopping.

### BACKGROUND

Presently, there are many web sites that provide product feedback and rating information online, but all of this information is after the sale of the product by someone who has already bought and/or used the product. The product feedback and rating is applicable to someone who has already bought and used the product. This product feedback and rating information does not offer the product rating and guidance for someone who has not bought the product. In other words, the product with respect to future consumer fit information is missing. The present customer feedback offers the generic product information not specifically applicable to a future customer/consumer. Presently, in many conventional systems, there is no automated service that offers the choice of ascertaining the product-potential customer fit before the product is bought. The downside of this is higher total cost of service. A number of times the product-consumer fit is bad and results in either product return or bad taste in the consumer's mouth, both of which add to the tangible and intangible costs resulting in the higher total cost of the product/service.

Also, in many conventional systems, it is difficult to aggregate the demand from various social circles of customers. This results in lower revenue for the product or service.

Presently, in many conventional systems, it is difficult to buy a product on someone's behalf or split up the bill between various parties for a purchase.

As well, the online shopping experience can be a solitary exercise. The end customer experience is usually bland and conversion rate for online purchases is low, at around 3%. People generally would like to consult others prior to making a purchase decision, but this option is not available. Further, as the baby boomers are getting old their vision is getting impaired. Additionally there is a segment of population who are physically impaired and may have difficulty manipulating their user input device, such as a keyboard, mouse, touch screen. Therefore, people, especially with visual and physical challenges, may need help in online shopping.

As well, some conventional web screen sharing systems are inefficient. For example, some conventional web screen sharing systems continuously screen capture an image of the entire screen of one user, which can lead to high data loads for that user, and rely on image or video compression or other techniques to compensate.

Additional difficulties with existing systems may be appreciated in view of the Detailed Description of Example Embodiments, herein below.

### SUMMARY OF THE INVENTION

According to an embodiment, the present application describes a system which offers to a person, with feedbacks, rating, and recommendations from another person, the choice to ascertain the product-potential customer fit before the product is purchase by the person.

According to another embodiment, the system offers a platform to solicit the personalized and customized product fit with respect to the potential consumer, before the product is bought. The system may offer lower total cost of the product by reducing product returns and this also improves customer goodwill. The system may also aggregate demand from not only the potential consumer, but also from the social circles of the potential consumer, and therefore may increase the sales of online business and conversion rates of consumers.

According to another embodiment, a system for social shopping comprises a backend configured for: receiving, from a front end within a first web browser application of a first device, a selection of a product from a third-party webpage originated from a third-party host server; generating, at the backend, a message with respect to the product; sending, from the back end, the message to a second device; receiving, from the second device, a response to the message; and transmitting the response from the second device to the front end for displaying and enabling a person to make a purchase decision with respect to the product.

### BRIEF DESCRIPTION OF THE DRAWINGS

Reference will now be made, by way of example, to the accompanying drawings which show example embodiments of the present application, and in which:

FIG. 1 is a block diagram, illustrating an exemplary system according to an example embodiment;

FIG. 2 is a flow chart showing an exemplary process of activating a client or an end customer;

FIG. 3 is a flow chart showing an exemplary process for a user to access the system of FIG. 1;

FIG. 4 is a flow chart showing an exemplary process of identifying an end user customer;

FIG. 5(a) is a diagram of a web screen sharing system, according to an embodiment, wherein scroll position between a receiving device and a sending device are matched, and a web browser window size and position are unchanged in the receiving device;

FIG. 5(b) is a diagram of a web screen sharing system, according to an embodiment, wherein scroll position, web browser window size and position are matched between the receiving device and the sending device;

FIG. 6 is a flow chart showing an exemplary web screen sharing process of the system in FIGS. 5(a) and 5(b);

FIG. 7 is a diagram of a web screen sharing system with peer assisted electronic commerce, according to an embodiment;

FIG. 8 is a flow chart showing an exemplary process for social shopping using the screen sharing system of FIG. 7;

FIG. 9 is an exemplary user interface screen of a webpage of the system of FIG. 7, shown with a home screen;

FIG. 10 is another exemplary user interface screen that is accessible from the user interface screen of FIG. 9, shown with a Login tab in a side toolbar of the webpage;

FIG. 11 is another exemplary user interface screen that is accessible from the user interface screen of FIG. 9, shown with a Sign Up tab in the side toolbar of the webpage;

FIG. 12 is another exemplary user interface screen that is accessible from the user interface screen of FIG. 9, shown with a Favourites tab, showing contacts of friends, families, and other favourite contacts, in the side toolbar of the webpage;

FIG. 13 is another exemplary user interface screen that is accessible from the user interface screen of FIG. 9, shown with a Shopping List tab in the side toolbar of the webpage;

FIG. 14 is another exemplary user interface screen that is accessible from the user interface screen of FIG. 9, shown with a Shopping List Message tab, for displaying messages from contacts in relation to a shopping item, in the side toolbar of the webpage;

FIG. 15 is another exemplary user interface screen that is accessible from the user interface screen of FIG. 9, shown with a Shopping List Feedback tab, for displaying ratings and comments from contacts in relation to a shopping item, in the side toolbar of the webpage; and

FIG. 16 is another exemplary user interface screen that is accessible from the user interface screen of FIG. 9, shown with a Recommendations tab, for displaying other recommended products in relation to a shopping item, in the side toolbar of the webpage.

Similar reference numerals may have been used in different figures to denote similar components.

### DETAILED DESCRIPTION OF EXAMPLE EMBODIMENTS

In order for the webpages to provide an improved online customer experience, remote users should be able to share the browsing and online shopping experience with others in their social network.

In this application, the term web browser window of a webpage can also refer to web windows, headless web windows, or web browser tabs within a web browser program. In all examples herein, any reference to operation by a “person”, “user” or “customer” similarly applies to a function or operation of a “device” being used by that person, user or customer.

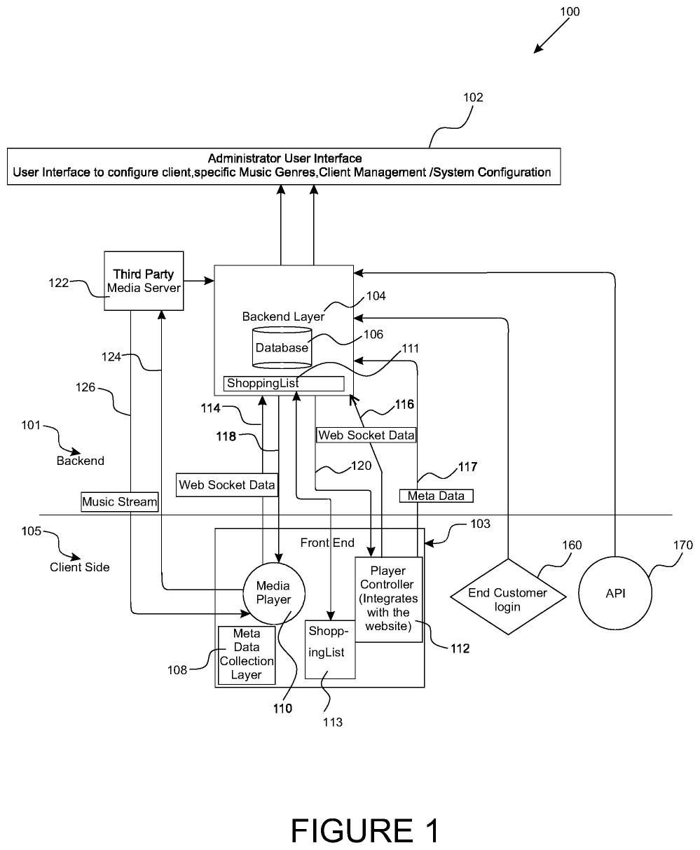

FIG. 1 is a block diagram illustrating a system 100 according to an example embodiment. The system 100 is configured for delivering seamless continuous play of personalized and customized media on a device. The system 100 is also configured for screen sharing and social shopping between two devices. System 100 may include a backend 101 and a client side 105, wherein the client 105 includes a front end 103. The front end 103 and the backend 101 are configured to communicate with each other. The backend 101 includes an Administrator User Interface (AUI) 102, and a Backend Layer (BL) 104. The BL 104 can be invisible to an online end customer, in that the end customer is merely browsing to a third party web domain that is registered with the BL 104. The BL 104 can comprise one or more processors. In other examples, the online end customer can specifically log into the BL 104. In some examples, the backend 101 includes a Media Server 122 (MS). In some examples, the MS 122 is a third party media server to the BL 104. In other examples, the MS 122 is a first party media server to the BL 104. The MS 122 can be a plurality of media servers. In some examples, MS 122 may be a virtual server in the cloud.

The MS 122 stores media files or has access to a library of media files. AUI 102 is an interface that allows a system administrator of BL 104, or a person with suitable access rights, to configure client/end user specific music genres, client management, and system configuration. BL 104 includes a database 106. The database 106 includes one or more memories, and include one or more processors. The database 106 can store User ID information (including user information, user history, user demographics, user preferences, etc.), Device ID information, and media file information about the media files. Typically, the database 106 does not store the media files themselves as those are stored in the MS 122.

The client side 105 includes a user device having the user interface visible to the online end customer, and includes the front end 103. Other end nodes can be on the client side 105. In some examples, the front end 103 is a module that is integrated or embedded in one or more browser windows from webpages of one or more same or different web domains. The webpages are from third party web domains that have been registered by third party clients (such as online businesses) with the system 100 at the backend 101. The front end 103 is embedded in the one or more web pages of one or more web domains of devices used by end customers. In some examples, the web browser windows include and are used to display the web pages. If an end customer opens more than one web browser window, the front end 103 can be embedded in each of the web browser windows.

The front end 103 includes a Meta Data Collection Layer (MDCL) 108, a Media Player (MP) 110, and a Player Controller (PC) 112. In some example, system 100 may include a web screen sharing application 113 (also referred to as screen sharing application 113) for providing screen sharing services and web screen sharing services. Screen sharing application 113 is configured to communicate with BL 104. Screen sharing application 113 may be embedded in one or more browser windows from webpages of one or more same or different web domains. Screen sharing application 113 is described in greater detail herein. In some examples, MP 110 is a media player and can display a logo and an equalizer graphic (static or dynamic) to illustrate that the MP 110 is launched. In some examples, media selection of the MP 110 is controlled by the end customer directly; for examples, the end customer can select the media from the front end 103. In some examples, media selection of the MP 110 is not controlled by the end customer directly, but is controlled through the backend 101. The PC 112 integrates into the webpage and has user controls for the MP 110.

When an online customer browses a webpage embedded with the front end 103 and chooses to play the media through the PC 112, BL 104 receives information 117, for example in the form of meta data, from PC 112 and sends a communication 118 to MP 110 and a communication 120 to the PC 112. The communications 118 and 120 include the specific media previously played by MP 110, such as a web link or media file identifier (media file ID) of the specific media in the Media Server (MS) 122, and the previous point stopped that was played in the front end 103 of the last web browser window for that device of the end customer. MP 110 sends a request 124 of playing the specific media at the stop point to the MS 122, and the MS 122 in response transmits media stream 126 starting from the stop point to the MP 110. In examples, media can include video, audio, and video and audio. MP 110 may then resume playing the specific media from the previous stop point. When the media stream 126 has been received from the MS 122, the MP 110 plays the media at the previous stop point. Once MP 110 has played the media, the information of the progress of playing the media is sent from MS 122 to the BL 104 for recording in the database 106.

In some examples, the MP 110 obtains the entire media file and identifies the start point based on the previous stop point information from the BL 104. In some examples, the MS 122 can feed the media to the MP 110 from the previous stop point. In other examples, MP 110 may only send a request 124 to the MS 122 of playing the specific media file ID without specifying the previous stop point, and the MP 110 obtains the entire media file having the media file ID from the MS 122, and the MP 110 starts the media file at the previous stop point.

When the media is playing on the current webpage or after the media has been played, MP 110 collects and transmits Web Socket Data 114 related to the webpage to BL 104. The PC 112 also collects and transmits Web Socket Data 116 related to the webpage to BL 104. The Web Socket Data 114 and 116 may include product information being displayed, location of the customer, time of the day information, customer taste or profile, such as mood and channel, and other information. Web Socket Data 114 and 116 is processed by BL 104 and the processed web socket data is stored in the database 106. Additionally, PC 112 also collects and transmits meta data 117 to BL 104. BL 104 processes the meta data 117 and the processed meta data is stored in the database 106.

By way of illustration, the end customer opens a first web browser window which has a first front end 103 integrated therein. The BL 104 send a media file ID to the first front end 103 of the web browser window. When the end customer plays the PC 112, the first front end 103 sends a request to the MS 122 with the media file ID, and in response the MS 122 sends or streams the media that was identified in the media file ID to the media player 110, which plays the media on the media player 110 of the end customer. When a second web browser window is selected or activated, a second front end 103 is integrated therein, the media at the first front end 103 stops playing at a stop point, and this information is communicated to the BL 104 using the Web Socket Data 114. The BL 104 sends the media file ID and the stop point to the second front end 103 using communication 118 to MP 110 and communication 120 to the PC 112. The second front end 103 requests the media from the MS 122 using the media file ID, and the MS 122 send or streams the media to the second front end 103 at the same stop point as from the first front end 103, wherein the front end 103 plays the media from the same stop point, therefore providing seamless and continuous media playing on the device of the end customer.

In some examples, the system 100 includes a generic library (GL) at the front end 103. The GL uses application programming interface (API) calls to collect, store/record, and send information associated with the end customer to the backend 101. The information captured by API calls includes, for example, number of web pages browsed by the end customer and online shopping cart status associated with the end customer, geographical location of the end customer, time of the day, unique device information associates with a specific end customer, visit information of the end customer such as Web site URL, time spent on the web site, web site or web page browsed, MP 110 status and media, such as songs, played, skipped or rated.

In some examples, the end customer may log into system 100 from the front end 103 using social media account. The social media account is registered with the system 100 in association with the unique end User ID that the system 100 uses to uniquely identify the end customer. The log in information may be stored in database 106. In an example, the end customer can log in, using end customer login 160, directly to the BL 104, such as with its registered Facebook™ account, authenticated through Facebook™, wherein the account is associated with a User ID stored in the database 106. In another example, the end customer may also log into system 100 using a first party web domain (first party to the BL 104) with their User ID that is registered with system 100. Applicant Protocol Interface calls (API) 170 can be used to record or facilitate these registration processes, for example, by recording a customer-registered User ID. In another example, API calls 170 may be used to access the number of webpages browsed by an end customer or the shopping cart status of the end customer. A similar login process can be performed by owners of the web domains.

In some examples, similar to a media player, the front end 103 of system 100 may play, stop, pause, forward and rate the media file (e.g. music file). The music file typically contains a song that can be classified within one or more music genres, or is played by one or more radio stations, podcasts, streaming service, etc. Example music file formats include MP3, Advanced Audio Coding (AAC), High Efficiency AAC (HE-AAC), Vorbis, and Opus. The music file can be controlled by Player Controller 112, which allows user control of the MP 110. In this case, PC 112 controls play, stop, pause, forward and rate the media file in the MP 110.

In system 100, BL 104 identifies a device and saves the identification of the device associated with a specific online end customer. The BL 104 generates the Device ID to uniquely identify the device. In some examples, IP address alone is insufficient since IP address resolution is only up to the household or office, but not to the specific device. IP address of a device is available to the system 100 when the device visits the third party web domains registered with system 100, because those third party websites have the front end 103 loaded therein, which is configured to communicate with the backend 101. In one household, however, there may be more than one device with the same IP address, and IP address may be changed from time to time. The medium access control (MAC) address of a device is also impractical, as it is not publicly available due to the security concerns. Instead, in some examples, BL 104 identifies the image of the browser settings from each device. Each web browser such as Microsoft Internet Explorer™ or Google Chrome™ associated with or installed in a device has a unique image of browser settings. When a device first visits a website registered with system 100, BL 104 generates saves the image of browser settings of the devices in database 106 of system 100. In each subsequent visit of the registered websites with system 100 by the device, BL 104 compares the image of browser settings of the device with the saved image of browser settings in database 106. If BL 104 finds a match, BL 104 identifies the device with the image of browser settings, and thus identifies the associated end customer of the device. Accordingly, BL 104 may provide personalized and/or customized services to the end customer, without the end customer necessarily logging in or being specifically registered at the BL 104. The personalized and/or customized services may include context-based music services. For example, system 100 may play a music file selected based on the context or content of a webpage or a website window. In some examples, image of the browser settings lead to 94% accuracy in identifying the individual device.

In some examples, BL 104 may identify the device with a Device ID which includes the image of the browser settings and the IP address used by the device and the User Agent data of the device. This approach may results in a good accuracy, such as 99.95% accuracy, in identifying the device and thus the associated end customer of the device. The IP address of the device may be saved in database 106. In this case, BL 104 saves the image of the browser settings and the IP address used by the device when the device first visits a website registered with system 100. In subsequent visits of any one of the websites registered with system 100 by the device, BL 104 compares both the image of the browser settings and the IP address of used by the device with those saved in database 106, and if a device match is found, BL 104 identifies the device and associated end customer to provide personalized and/or customized services to the end customer. In other examples, the Device ID is generated using the image of the browser settings, the IP address and User Agent data of the device.

For example, a user might log into two separate devices using their User ID. The BL 104 can ensure there are no media playing conflicts by generating the Device ID, which is different for each of the two separate devices. In examples, the front 103 sends a request to the BL 104 along with the Device ID (and other information) of the device currently being used by the end customer, and the BL 104 responds with the proper Media ID and stop point of the media having that Media ID to the front end 103.

BL 104 may record customer profile and taste in database 106 over time, such as customer information, image of the browser settings, IP address of a device, User Agent data, and customer taste/profile, such as mood and channel.

In some examples, personalized and/or customized services include providing personalized and/or customized media based on factors related to the end customer, media, and events, etc. For example, the factors include product or service provided by online business, different products/services associated with different media or music; end customer background, such as age and taste (different people would like to listen to different music); end customer history such as how many times the end customer visited a specific webpage; changing music depending on the time spent during the previous visit and when was the last visit; music change or continuation based on the history of the various online business; geographical location of the end customer; external events; music genre list and popularity; current events such as changing political, economic, social, technological environment; cultural events, such as festivals, holidays, special events, etc.; external environment such as weather or time of day or day of the week to account for different music files to suit different time of the day. For example, when an end customer is browsing real estate on a web site, the contents of the webpage, such as the pictures of the real estate property and or the texts on the web browser window may be used as factors for system 100 to select a media file to be played on the active web browser window. In some examples, the BL 104 may be configured to determine the contents of the webpages, for example from image or text recognition, and then select a suitable music file based on the context from the contents of the webpages.

By providing personalized and/or customized services to the end customer, system 100 improves end customer experience, increases the time end customer spending on the website on online business by playing media, such as music, harmonious with the products and thus eliciting products buying, increase the cart size, customer loyalty, and improves conversion rate.

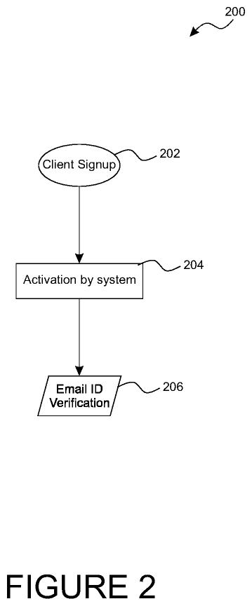

FIG. 2 is a flow chart showing an exemplary process 200 of activating a client. The client can include third party web domain owners and online businesses. The client can include an end customer (end user). In the example of FIG. 2, a new client subscribes to the services provided by the BL 104 (step 202), for example, by providing required information, such as email ID, name and address of the client, etc., and may agrees to pay a fee for the various services of the BL 104 or business layer 406. The services of the BL 104 may be subscribed, for example, by downloading and installing the front end 103 on a web browser application of the client. In an example, the installed front end 103 is embedded with the browser used on the device of the client. In another example, the downloaded front end 103 is embedded within the website of the client, such as a third party online business that is logging into the BL 104. In another example, a first party website hosted or operated by the BL 104 is used to activate the client.

The BL 104 or the business logic 406 receives the required information from the client (at step 204). The BL 104 may also conduct email ID verification (step 206) with the email ID of the client. In some example, process 200 also allows the client to set out preferred sections of media, which may be modified by the client in the future in client-related configurations in the BL 104 or the business logic 406. After the client has subscribed to the services, the BL 104 may further configure the settings of the front end 103 with AUI 102, for example, based on the subscription of the client and the client's preference.

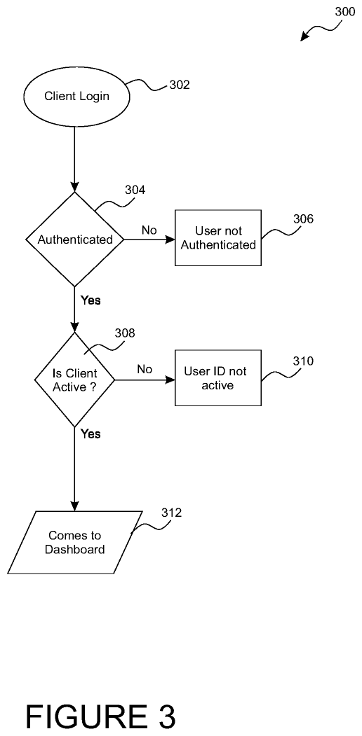

FIG. 3 is a flow chart showing an exemplary process 300 for a user, such as a client, to access the system 100. After the user has been activated in system 100, in FIG. 3, the user first attempts to log into the system 100 with login credentials (step 302), for example, with a username and password, or a User ID, or a social media account. The login credentials may be generated by BL 104, or created by the user, when the user first subscribes to the services of the system 100. At step 304, the BL 104 authenticates the user by, for example, comparing the credentials provided in the login information of the user with those stored in system 100. In other examples, the social media account is authenticated by the social media provider. If the credentials provided by the user do not match those stored in the system 100, the user is not authenticated and BL 104 declines the user's login request (step 306). If the credentials provided by the user match those stored in the system 100, the user is authenticated to be a legitimate user and BL 104 continues to verify whether the user is active (step 308). If the User ID of the user in system 100 is not active (step 710), the BL 104 considers the user to be inactive and denies the user's request to access to system 100. If the User ID of the user in system 100 is active (step 310), the user is granted access to system 100, such as the dashboard (step 312), to access the services provided by system 100. The dashboard 312 may be used to show relevant information to the user, such as client sign in information and billing information, and to provide access to the client profile.

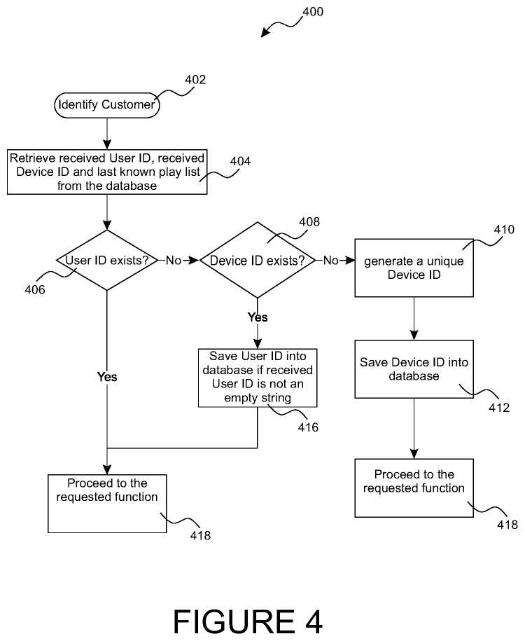

FIG. 4 is a flow chart 400 showing an exemplary process of identifying an end user customer. After the user has been authenticated and identified, BL 104 may proceed to identify the end customer (step 402). BL 104 identifies and authenticates the end customer with the login credentials. At step 404, BL 104 retrieves from the database 106 the received User ID and received Device ID associated with the end customer. In case that User ID and Device ID in database 106 are empty strings, it is not necessary to retrieve User ID and Device ID from the database 106. In case the end customer has not logged onto business client's website, User ID may be an empty string, and Device ID may be a non-empty string. In other words, the end customer is identified by the Device ID as previously described.

With the received User ID, BL 104 determines whether the User ID exists in system 100 by querying the database 106. If the User ID exists in the BL 104, namely that the User ID is a non-empty string, the front end 103 (end customer) proceeds to continue the functions requested by the customer, such as online shopping (step 418). If the User ID does not exist in the BL 104, namely that the User ID is an empty string, the BL 104 proceeds to determine whether a Device ID associated with the end customer exists in the BL 104 (step 408). If the Device ID associated with the end customer exists in the BL 104, BL 104 saves the User ID in database 106 if the received User ID is not an empty string (step 416), and proceeds to perform step 418. If a Device ID associated with the end customer does not exist, BL 104 generates a new Device ID in association with the end customer (step 410), saves the new Device ID into database 106 of the BL 104, and proceeds to the requested functions such as social shopping, for the identified end customer (step 418). As described herein, the Device ID may be an image of the browser settings of the device, or generated from a combination of the image of the browser settings and IP address of the device, or generated from a combination of the image of the browser settings, and the IP address of the device, and User Agent data of the device.

Settings of the BL 104 may be configured by different users. Different levels of users may access different screens of BL 104, for example, via AUI 102. In some examples, screens of BL 104 may include System setting module, which is accessible to system and “Client's Admin Users Only”, and Client Management/Multiple Lists Screen. Client Management/Multiple Lists Screen may include search function by querying database 106. Client Management/Multiple Lists Screen may further include: a. Full Details View Screen with Add/Update Screen (accessible to system and “Client's Admin Users Only”), b. Music Management (accessible to system), c. DB Query Console (accessible to system), and d. Manage Profile (accessible to “All”).

The provider of system 100, and “Client's Admin Users Only” are examples of the administrator of system 100. Client in the case of “Client's Admin Users” includes online business and end customers that have subscribed to the services of system 100. “All” includes the administrator of system 100, the subscribed online business and end customers, the end user browsing the websites of the subscribed online business, and other parties obtained access to system 100 from the administrator.

A subscribed user registered with system 100 may login to system 100 via a login interface of system 100, such as a webpage, or other user interfaces. The login interface applies to the subscribed users, such as online business, subscribed end customers, and system administrator. The subscribed online business, subscribed end customers, and system administrator may log into system 100 by providing required information in order to identify the subscribed users. For example, the required information may include email address, user name, password, and so on. If a potential user, such as an online business, or an end customer, which has not subscribed or has not registered with the services of system 100, the online business, or the end customer may use a signup interface to sign up with system 100 by providing required information, for example, name, company name, company website, email address, and password set by the potential user. The required information for logging in and signing up with system 100 may be varied as long as system 100 can sufficiently identify the user and the website of the user to be associated with the services provided by system 100. Since there are multiple end users associated with one online business client, additional information may be provided by an Account Manager who has additional information about the online business client.

In some examples where end customers have high privacy setting, the registered websites in system 100 may install an Asynchronous JavaScript and eXtensible Markup Language (XML) (AJAX) Plugin and embed the front end 103 in the static part with website content opened using the AJAX Plugin. In some examples, AJAX Plugin blocks a web browser window from refreshing.

In an example, the BL 104 identifies a user device and generates the Device ID. A browser fingerprint (image of browser settings), User Agent data, and the IP address (typically the router IP address) are determined by the BL 104. Other example browser IDs can be used other than the browser fingerprint. The combination of the browser fingerprint, User Agent data, and router IP address is used to generate the Device ID, which is unique to the device when it is accessing the BL 104.

The browser fingerprint of the user device can be determined by the BL 104 using the JavaScript™ function “Fingerprintjs2”, which is a unique JavaScript™ fingerprint of the browser settings of the user device in the form of a hexadecimal sequence, as understood in the art. The User Agent data of the user device is determined by the BL 104 from a HTTP request header received from the front end 103, and which includes the application type, operating system, software vendor or software version of the user device. In an example, the Device ID can be generated by aggregating this combination, optionally along with other computations (e.g. hashing). In various examples, one, two or three of the three parameters of the combination are used to generate the Device ID. More parameters can be used in other examples.

The BL 104 may present different information to a user via various dashboard screens. In some examples, BL 104 may include a dashboard home screen, and information of BL 104 or client may be collected and illustrated on the home screen in a user-friendly manner. For example, some data may be illustrated with diagrams or chart. The dashboard home screen may include information, such as “System Settings”, “Profile Management”, “Admin Activities” related to “Music”, “Clients”, and “Query”, “Reports” related to some or all of the information related to system 100, and “Billing”, etc.

In some examples, BL 104 may include a dashboard client management screen as a sub-screen of the dashboard home screen. For example, the client management screen may allow system administrator to search subscribed clients, to display information related to the client of interest, such as client's name, status, account manager, and to manage the client, such as deactivating a client and managing playlist associated with the client.

In an example, BL 104 offers personalized greeting message to the end customer when an end customer logs into system 100, by recording the greeting message (e.g., from the CEO or VP) that welcomes the end customer for online shopping or by using the Artificial Intelligence text to speech application in welcome/promotional message.

In another example, system 100 can promote products. Once the purchase is made, system 100 can be used as a confirmation platform. In some conventional cases, this is offered by the salesperson in the brick and mortar store. System 100 enables confirmation communication with the end customer, such as by playing the audio “you got a good deal” or “With 10% off, you saved $20 today”. These messages reinforce the savings for the end customer and provide the end customer with similar experience as in a brick and mortar outlet.

Once the end customer logs out, BL 104 may also configure the welcome/promotional message by thanking the end customer and along with an offer to come back, for example “thank you”, “Have a nice day”, “Merry Christmas and Happy New Year,” “hope to see you soon,” etc.

In some examples, BL 104 may include a dashboard database query console screen as a sub-screen of the dashboard home screen. With the dashboard database query console screen, a client may select the tables of database, such as database 106, and the fields of the selected tables such as columns of the selected tables, and then query the information in the selected fields. For example, the tables may be related to clients, visits, system settings, and system users.

In other examples, BL 104 may cross validate the online end customer even before the end customer has signed in system 100, in order to provide promotional opportunities to the online business, such online retailers. For example, most online businesses have loyalty programs or customer profiles for signing on into their databases. The signing in/up occurs just prior to checking out. As soon as the end customer appears or comes online, BL 104 may then cross validate an end customer after the end customer signs in or during the online shopping period. For example, by analyzing the information stored in the database 106 of system 100, BL 104 determines preferences of an end customer, and communicates the preferences of the end customer to relevant online business. The online business may then provide products that are tailored to the preferences of the end customer to increase sales.

Referring again to FIG. 1, front end 103 may include a ShoppingList application 113 for providing online social shopping services. The back end 101 may also include a corresponding ShoppingList application 111 to coordinate with the front end 103. In some examples, the ShoppingList application 113 is composed by Javacript™ codes embedded in the web page, for example, or in other examples as browser extension or browser addon of the web browser application. With ShoppingList application 113, a person may conduct online social shopping in real time with one or more people from social circle of the person. The ShoppingList application 113 may provide web screen sharing, which can be Person A sharing with Person B, and Person B may be multiple people. All references to a “person” similarly apply to the function or operation performed by their respective devices.

Many existing conventional screen sharing applications typically takes a snapshot picture of a screen and shares the whole screen with others irrespective of the type of program, applications and information being displayed. Therefore, those existing screen sharing applications are data intensive, and sometimes require additional software to be downloaded on computer.

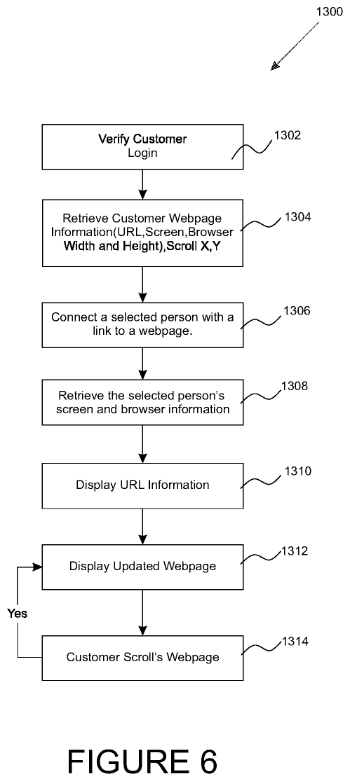

After customer (Person A) signed up with system 100 for the online shopping services, the user subscribes ShoppingList application 113. The process of signing up with system 100 is same as the process described above in FIG. 6, for example. In some examples, ShoppingListapplication 113 included in the front end 103 may be embedded in the website or web page on the device associated with the user subscribed with the services, or an independent web application mobile application. In some examples, ShoppingListapplication 113 may be embedded in a website or as a web browser extension, for example on the right hand side of the webpage for online shopping, including online social shopping.

In some examples, if ShoppingListapplication 113 is embedded in the web site, no additional software has to be downloaded by the sender (Person A) or receiver (Person B). If ShoppingListapplication 113 is embedded in the browser extension, only a one-time software installation by Person A is required, which can be Java code or other suitable code.

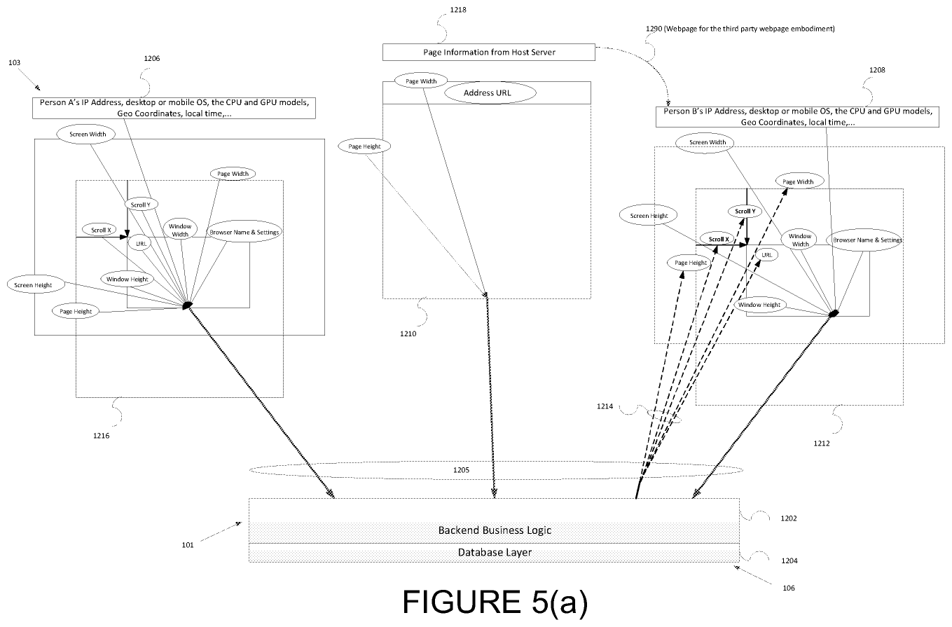

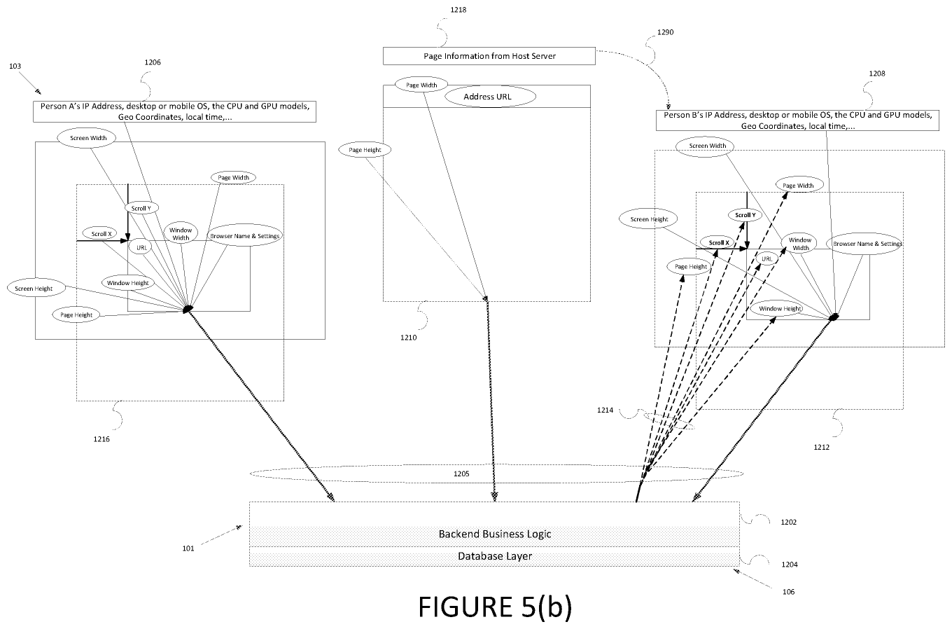

References are made to FIGS. 5(a), 5(b) and 6. FIG. 5(a) is a diagram of a web screen sharing system, according to an embodiment, wherein scroll position is matched between Person A and Person B, and the web browser window size and position are unchanged in Person B. FIG. 5(b) is a diagram of a web screen sharing system, according to an embodiment, wherein a plurality of webpage view settings, including the scroll position, web browser window size and position, are matched between Person A and Person B.

When browsing the web page 510, Person A opens a web page 516 having at least one web browser window embedded with the front end 103 including the ShoppingListapplication 113. The web browser window has a window width and a window height. Person A may initiate the ShoppingListapplication 113, for example, by clicking on a control button on the front end 103 with the ShoppingListapplication 113 embedded in the webpage 516. The BL 104 requires Person A to log into the system 100. After BL 104 has verified the login of Person A, Person A may access ShoppingListapplication 113 (step 1302). The process of signing up with system 100 is same as the process described above in FIG. 3. In some example, if Person A has logged into system 100 once, all of the subscribed services are available to Person A.

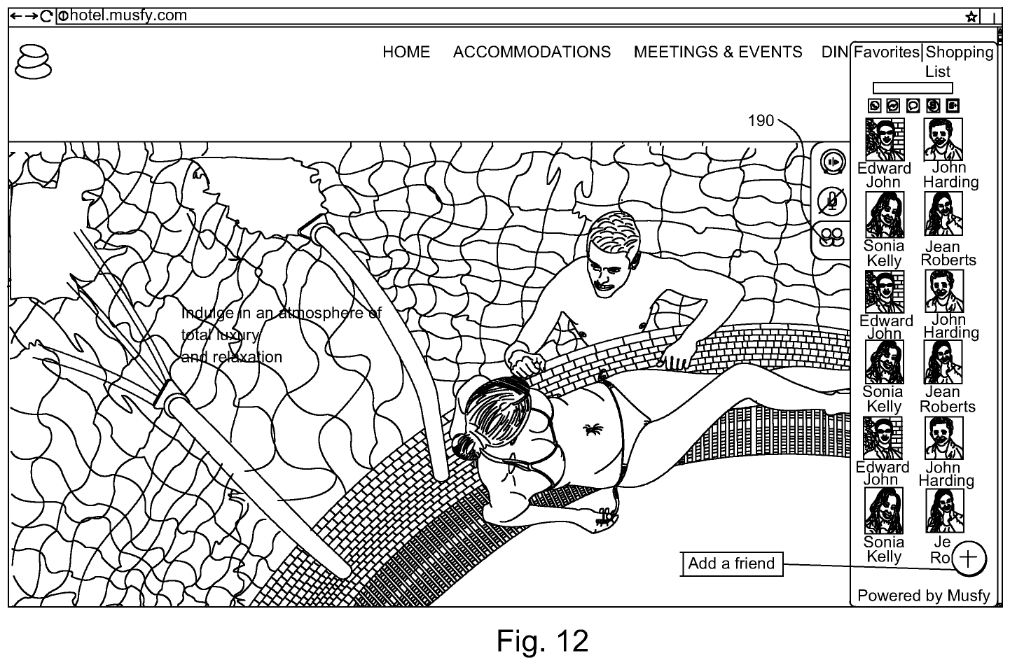

In the examples of FIGS. 5(a) and 5(b), after Person A logs in system 100 and starts ShoppingListapplication 113, the front end 103 may collect information of Person A and communicate, via a communication network 1205 such as the Internet, with the BL 104. In this example, Person A is browsing a third party webpage 1210 of a third-party host server 1218. The third-party webpage 1210 is loaded with the front end 103 and is registered with the BL 104. In the examples of FIGS. 12 (a) and 12(b), the front end 103 collects and sends to Backend Business Logic (BBL) 1202 webpage information related to Person A via the communication network 1205, such as current Uniform Resource Locator (URL) of the webpage 1210, screen width and height of Person A's device 1206, the window width and height of the web browser window, the web browser window position (Window Screen Top, Window Screen Left) on the screen of Person A, the webpage width and height of the webpage 1216, and the coordinate of the scroll X and Y (Step 1304). In some examples, webpage information related to Person A that the front end 103 collects and sends to Backend Business Logic (BBL) 1202 includes the locations of the web browser window position on the screen of Person A 1216 (Window Screen Top, Window Screen Left). The BL 104 in the example of FIGS. 12(a) and 12(b) includes the Backend Business Logic (BBL) 1202, Database Layer (DL) 1204. In some examples, the DL 1204 may include database 106. The BBL 1202 and DL 1204 are an example of BL 104 (FIG. 1) as described above. With the information of Person A, the front end 103 sends BBL 1202 the URL of the webpage 1210 Person A is browsing, the dimensions of the webpage 1216 of Person A, the screen width and height of Person A 1206, the Window Width and Height of Person A 1216, the web browser window position (Window Screen Top, Window Screen Left) on the screen of Person A, and the relative position of the contents of the webpage 1216 of Person A is browsing based on the position of scroll X and Y. In some examples, the Page width and Page Height of the webpage 1210 can be collected from the third party Host Server 1218 via the communication network 1205 such as internet. Any changes to these parameters on the webpage 1216 of Person A are received the BBL 1202, and the BBL 1202 causes these same changes to be changed on the web browser of Person B. Note that some web sites only have scroll Y, but is still referred to as scroll X and Y herein.

In some example, the front end 103 may also collect and send additional information of Person A including IP address, the operation system of the Person A's device, such as a desktop or a mobile device, the models of the Central Processing Unit (CPU) or Graphics Processing Unit (GPU) used in the Person A's device, geographical coordinates and local time of Person A, and browser name and settings of Person A's device 1206 to BBL 1202 through Communication network 1205. In some examples, the additional information may be used for determining and displaying the new scroll X and Y coordinates of the webpage for Person B, based on the devices used by Person A and Person B. For example, Person A may use a computer while Person B may use a mobile phone. The information of the shared webpage may be displayed on the Person B's device according to the device used by Person B so that webpages displayed on the devices of Person A and Person B have the same contents, wherein the browser of Person B uses the information to effect the same ratio and proportion of the size and scroll X and Y coordinates, and/or web browser window position on the screen (Window Screen Top, Window Screen Left). Any changes to these parameters on the webpage 1216 of Person A are received the BBL 1202, and the BBL 1202 causes these same changes to be changed on the web browser of Person B.

In other examples, this additional information of Person A may be used for cross validating a customer, such as Person A, even before the customer has signed in to the system 100, for example, by using the link and/or Person A's device information, IP Address and Browser Settings to uniquely identify Person A or Person A's device. The information can be used to determine a Device ID of Person A as described herein, in order to uniquely identify Person A (with or without requiring login by Person A, or to identify Person A from past use of the Backend Business Logic (BBL) 1202 prior to Person A even registering). As mentioned, the Device ID can be based on, for example, image of browser settings and/or IP address of the device and/or User Agent data, and/or this additional information. Therefore, in some examples, the Device ID can be used to, for example, uniquely identify the customer, welcome the customer with their name, ask them if they are who we think they are and even without having them signed in and link the future activity like shopping with the customer even without them having signed in.

In some examples, the backend 101 may receive webpage information, the additional information, and/or the webpage view settings of the webpage 1216 displayed on the Person A's device simultaneously or prior to or subsequent to detecting selection of the link by the Person B's device.

In some examples, the webpage information, the additional information, and subsequent information may be associated with a timestamp to indicate the time when the front end 103 sends the information to BBL 1202. With the timestamp, the BBL 1202 may determine the latest information related to the Person A.

BBL 1202 may save the received information from the front end 103 in the DL 1204, such as in database 106. This information of Person A can be used to determine the Device ID, in some examples. This information of Person A can also be used to select the particular media to play on the devices of Person A and Person B, in some examples. In some examples, the BL 104 may continuously save any changes in the webpage information and/or additional information received from the front end 103 in the database 106.

If Person A would like to share the webpage 1216 with the same view setting as his or her web browser window with Person B, Person A may initiate the web page sharing process of the ShoppingList application 113 with one or more selected persons, e.g. Person B as shown. For example, Person A may click on one or more contacts on a contact list of Person A. The contact list is appeared in the front end 103 including the ShoppingList application 113, such as friend list of Person A. If a person with whom Person A would like to share the webpage is not on the contact list, Person A may add the person's information in the contact list or friend list. After Person A selects Person B, the BBL 1202 may generate a link containing the webpage information. The link may include a link control button, and/or a webpage address. BBL 1202 may send, via communication network 1205, the link to the selected Person B (step 1306), such as sending the link to Person B's device 1208, for example, via at least one of an email, phone, social media platform(s), such as Facebook™, WhatsApp™, text message, or other communication methods. When Person B receives and clicks on the link, a webpage 1212 may be opened. The front end 103 of Person B may communicate with the BBL 1202. The BBL 1202 may authenticate the link sent to Person B is a legitimate link from a signed up user, for example, by determining that the link is originated from Person A. The BBL 1202 may retrieve, as illustrated in webpage 1212, screen and browser window information of Person B from device 1208 of Person B, such as screen width and height of the device 1208, the window width and height of the web browser (step 1308), the web browser window position (Window Screen Top, Window Screen Left) on the screen of Person B.

In some examples, the link may include the link button and/or webpage address to go to. The link may include an address to the first party webpage. In some examples, the backend 101 may receive a third-party webpage from a third-party host server 1218, and generate a first party webpage including the third-party webpage rasterized as an image within the first party webpage. The backend 101 may send the first party webpage to the Person B's device in response to the link being selected by the Person B's device.

In some examples, in parallel to sending the invite to Person B, the backend 101 requests the rasterized image of the Person A's browser window to Person A's front end 103 based on the browser window location on the screen of Person A's device. In response, the front end 103 prepare the image and sends to the back end 101. The back end 101 saves the rasterized image in the DL 1204, such as in database 106. Any changes in the webpage display on Person A's device screen triggers an update to the rasterized image and the changes are communicated to the backend 101 and saved in the DL 1204, such as in database 106. In some examples, the last five rasterized images are saved in the DL 1204 and rest are purged.

In some examples, as an alternative that the backend 101 does not sends the last saved Person A's webpage domain URL information to the Person B's front end 103 as described above, the back end 101 uses inline frame option, prepares a First Party webpage, such as “musyfy.com/sender”, with the most recent or latest rasterized image saved in the DL 1204, such as in database 106, for Person B. The back end 101 sends the First Party domain address link, such as “musyfy.com/sender”, to Person B's front end 103. The back end 101 may notify Person A when or after Person B has joined the screen sharing. Person B's front end 103 may loads the First Party Webpage such as “musyfy.com/sender”. The back end 103 may continuously update the First Part Webpage, such as “musyfy.com/sender”, with the latest Rasterized Person A's Browser Screen. The updated First Part Webpage may be displayed by the Person B's front end 103.

In some examples, Person B may send to BBL 1202 additional information related to the Person B's webpage 1212 via the communication network 1205, including the IP address, the operation system, such as a desktop or a mobile device, the models of the Central Processing Unit (CPU) or Graphics Processing Unit (GPU) used in the device 1208, geographical coordinates and local time of Person B. In some examples, the additional information may be used for determining and displaying the new X and Y coordinates of the webpage for Person B, based on the devices used by Person A and Person B. For example, Person A may use a computer while Person B may use a Mobile phone. The information of the shared webpage may be displayed on the Person B's device according to the device used by Person B so that webpages displayed on the devices of Person A and Person B have the same contents. In other examples, the additional information may be used for cross validating a customer, such as Person B, even before the customer has signed in to the system 100, for example, by using the link and/or Person B's device information, IP Address and Browser Settings to uniquely identify Person B and Person B's device. BBL 1202 may save the received information from the front end 103 of Person B in the DL 1204, such as in database 106. This information of Person B can be used to determine the Device ID, in some examples, for unique identification of Person B. This information of Person B can also be used to select the particular media to play on the devices of Person A and Person B, in some examples.

In some examples, the webpage information, the additional information, and subsequent information may be associated a timestamp to indicate the time when the front end 103 of Person B sends the information to BBL 1202. With the timestamp, the BBL 1202 may determine the latest information related to the Person B.

After the link received by the Person B's device is clicked by Person B, a new web browser window of the webpage 1212 is generated by the BL 104 and code for the new webpage 1212 is transmitted to Person B. In some examples, the code from the backend 101 to the Person B's device may include an address of a third-party host server, such as 1218, for the Person B's device to retrieve the third-party webpage from the third-party host server.

In some examples, the backend 101 is further configured for receiving a width and height of the third-party webpage from a third party host server, such as server 1218.

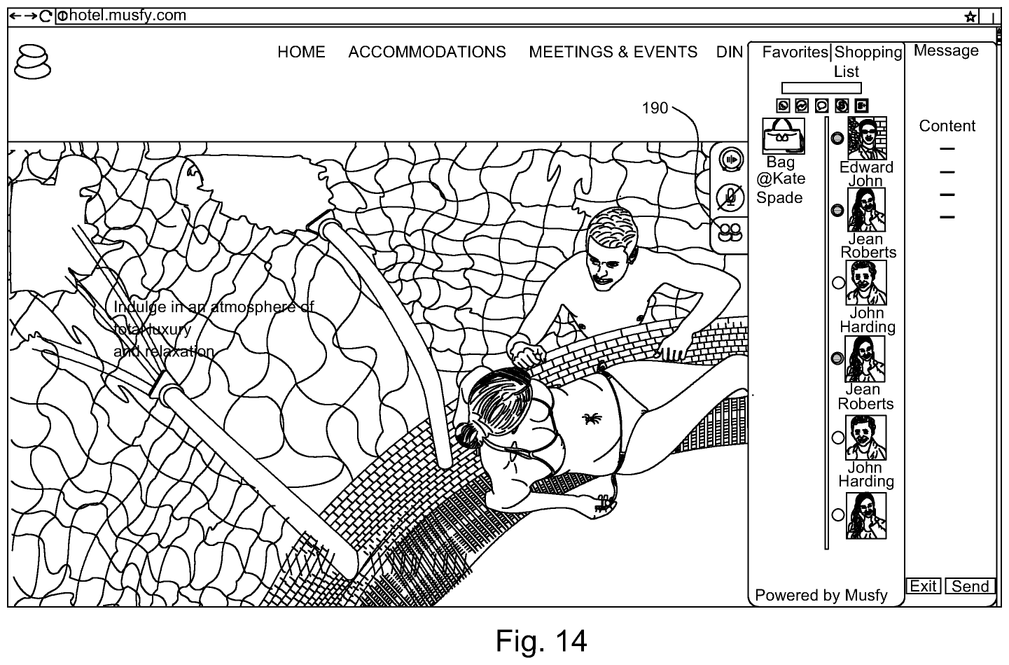

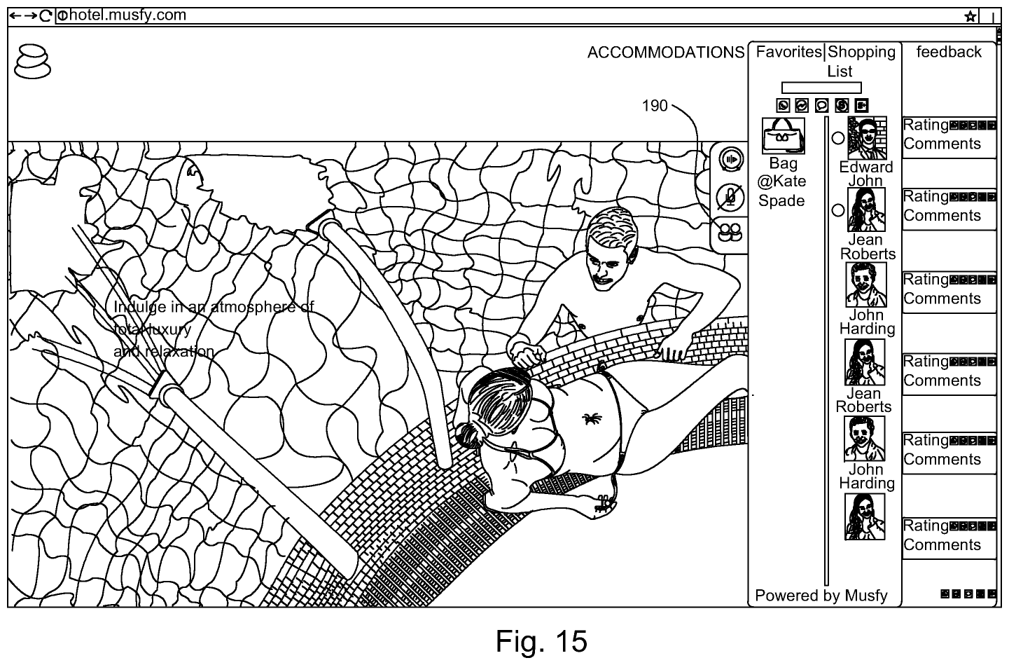

In some examples, the BL 104 may notify Person A that Person B has joined the screen sharing process after the Person B has clicked on the link. In some examples, the front end 103 on the Person A's device is configured to receive a message from the backend 101 that the link was selected by the Person B's device, and output an indication on the Person A's device to show that the Person B's device is web screen sharing the web browser window with the Person A's device. The webpage 1212 is opened on the device of Person B using the Person A's webpage settings, and in some examples with the top of the webpage is appended or marked with the original web page address or URL of the webpage 1210 (step 1310) (note: step 1310 having the appended or marked original URL is shown in FIGS. 5(a) and 5(b) but not shown in FIG. 14 or 15). In some examples, the BL 104 may send the latest web page address or URL of the webpage 1210 based on the timestamp. In some examples, the backend 101 receives, from the Person A's device, webpage view settings of the third-party webpage 1216 displayed on the Person A's device comprising width and height of the first web browser window that is displaying the third-party webpage 1216, and first scroll X and Y positions of the first web browser window that is displaying the third-party webpage 1216 on the screen of Person A.

In the example of FIG. 5(b), the browser window height and width setting can be made to be the same relative window size for Person A and Person B, along with the same webpage view settings. Alternatively, as shown in FIG. 5(a), the browser window height and width settings are not modified and are kept as they are, but only the page view settings are modified so that Person A and Person B view the similar location on the webpage.

In the example of FIG. 5(a), the BBL 1202 may send in 1214 the updated webpage width and height, the URL, and Scroll X and Y for displaying the shared webpage on the screen of Person B's device. In this example, the Person B's device uses the original web window height and window height, and original web window position, already displayed within the web browser application of Person B's device, without modification of the window width and widow height, or web window position, being displayed on the shared webpage.

In the example of FIG. 5(b), the BBL 1202 may send in 1214 the updated webpage width and height, ULR, Scroll X and Y, window width and window height, and web browser window position on the screen, for displaying the shared webpage on the screen of Person B's device. In this example, the Person B's device uses the modified web window height and window height as provided by the BBL 1202.

In some examples, referring to FIG. 5(b) the new web browser window of the webpage 1212 of Person B has the same relative height and width of the webpage 1216 on Person A's screen, for example, by using window “resizeTo( )” code with the width and height of Person A's webpage 1216. In some examples, the backend 101 may transmit, to the device of Person B, code for displaying of the webpage 1210 on the web browser window of the Person B's device. In some examples, the backend 101 may also transmit to the Person B's device webpage view settings for displaying of the webpage 1212 on the Person B's device to effect a same relative webpage view setting as the view settings of the webpage 1216 displayed on Person A's device. The webpage view settings transmitted to the Person B's device may include updated width and height of the web browser window on the Person B's device and updated scroll X and Y positions of the web browser window on the Person B's device. For example, using the webpage view settings transmitted from the backend 101, Person B's device may display a web browser window on the Person B's device with the updated width and height of the web browser window, and with the updated scroll X and Y positions. In some examples, the backend 101 derives the updated width and height of the web browser window and updated scroll X and Y positions based on size of the webpage 1216 displayed on the Person A's device, the relative position of the webpage 1216 on the screen of the Person A's device, the screen size of Person B's device, so that the webpage 1212 is similarly displayed on the Person B's device in relation to the overall screen size of the Person B's device, and thus the webpage 1212 has a same relative webpage view setting as the view settings of the webpage 1216 displayed on Person A's device. For example, if the top left corner of webpage 1216 displayed on the Person A's device is ¼ below the top edge and ¼ right from the left edge of the screen of Person A's device, the top left corner of webpage 1212 is also displayed on the Person B's device is ¼ below the top edge and ¼ right from the left edge of the screen of Person B's device. In some examples, the size of the webpage 1216 is proportional the size of the screen of Person A, and the size of the webpage 1212 has the same proportion to the size of the screen of Person B, for example, as set in the updated width and height of the web browser window, and with the updated scroll X and Y positions on Person B's device. As some webpages may have text shifting that depends on the size of the web browser window, the backend 101 can accommodate for the text shifting when determining the scroll X and Y positions of Person B's device, so that approximately the same text is being displayed concurrently to Person A and Person B.

In some examples, the backend 101 determines the same relative webpage view setting, for example, by calculating a proportion of the width and height of the web browser window to the screen width and height of the Person A's device. The backend 101 may also determine a same proportion of the second width and height of the second web browser window to the second screen width and height of the Person B's device.

In the case of FIG. 5(a), the webpage 1212 is displayed on the screen of Person B with the existing web browser window size and position of Person B. In such a case, the webpage 1212 is displayed on the screen of Person B with the scroll X and Y positions that generally correspond to what is seen on the screen of Person A. The web browser window size and position of Person B are not changed in this example.

In the case of both FIG. 5(a) and FIG. 5(b), in some examples, when the webpage view settings of the webpage 1216 are changed in the Person A's device, for example, the change of position of the webpage 1216 in relation to the screen of the Person A's device, or the change of width or height of the webpage 1216, the backend 101 receives, from the Person A's device, subsequent to the detecting selection of the link by the Person B's device, update to the webpage view settings of the webpage 1216 displayed on the Person A's device. The backend 101 may re-derive the width and height of the web browser window and scroll X and Y positions for the webpage 1212 based on size of the webpage 1216 displayed on the Person A's device, the relative position of the webpage 1216 on the screen of the Person A's device, and the screen size of Person B's device. The backend 101 may then transmit, to the Person B's device, updated webpage view settings of the webpage 1212 to effect the same relative webpage view setting as the updated view settings of the webpage 1216 received from the first device as described above.

BBL 1202 determines the scroll X and Y positions on the webpage 1212 of Person B and settings of width and height of the webpage 1212, based on the webpage information or additional information of Person A, such as webpage width and height information of Person A, screen and browser information of Person A such as screen width and height of the device of Person A, Scroll X and Y of Person A and the screen and browser information of Person B, so that the contents displayed on the webpage 1212 of Person B are the same as those displayed for Person A. BBL 1202 may then, as illustrated in 1214, send the updated information to Person B's webpage 1212.

The webpage 1212 of Person B displays contents of the webpage 1218 based on updated scroll X and Y positions 1290 on the webpage 1212 with the URL and the screen and browser information of Person B (step 1312). In some examples, the device of Person B may run “scrollto( )” or “scrollby( )” method of JavaScript from the BL 104 to scroll the webpage 1212 to the position as appeared on Person A's webpage 1216. In some examples, the device of Person B may run “resizeTo( )” method of JavaScript from the BBL 1202 to resize the new window to the width and height of the webpage 1216 of Person A. In some examples, the device of Person B may run code to move the new window to the relative web browser window position on the screen (Window Screen Top, Window Screen Left) of Person A, when such information is received from the BBL 1202. In some examples, the system 100 may allow Person B to sign in to system 100 for screen sharing of the Person B. In some examples, Person B does not need to sign in for screen sharing, and merely accesses the webpage 1212 using the link.

In some examples, the webpage view settings of the webpage 1216 displayed on the Person A's device include a first position of the web browser window on the Person A's device. The webpage view settings of the webpage 1212 on the screen of Person B's device may include a second position of the web browser window on the Person B's device, to effect a same relative position on the Person B's device as the first position on the Person A's device. In some examples, the first position includes a first top position of the web browser window on the Person A's device and a first left position of the web browser window on the Person A's device. The second position may include a second top position of the second browser window and a second left position of the second web browser window on the Person B's device. In an example the “moveTo( )” or “moveTo( )” method of Javascript™ can be used to move the second browser window to the new position.

In some examples, when the Person A's device changes the first position of the web browser window that is displaying the webpage 1216 to an updated first position, the backend 101 receives the change and transmits code to the Person B's device to change the second position of the second web browser window displaying the webpage 1212 to an updated second position that is a same relative position to the screen width and height of the second device as the updated first position to the screen width and height of the first device of the first device.

In some examples, the BL 104 may use the inline frame function to prepare a webpage for Person B with the Person A's URL on a first party web domain hosted or controlled by the BL 104. The webpage is embedded in the First Party Domain, such as “musyfy.com/sender”. The BL 104 sends the First Party Domain link to the front end of Person B. And the BL 104 notifies Person A that Person B has joined the Screen Share. Person B's front end may then loads the First Party webpage, such as “musyfy.com/sender”. The BL 104 calculates the Scroll X and Scroll Y on the webpage based on the information provided by Person A and Person B. The BL 104 may updates the Scroll X and Scroll Y positions for the First Party webpage on the front end of Person B. First Party Webpage is updated with the new Scroll X and Y coordinates when Scroll X and Y coordinates on Person A's webpage change.

Each time when Person A scrolls the shared webpage 1216 (step 1314), the screen sharing application 113 repeats step 1312 on webpage 1212 of Person B, for example, by displaying on the screen of Person B the contents on the webpage 1212 based on current scroll X and Y positions on the webpage 1216 of Person A. As such, the webpage 1212 appears on Person B's screen reflects real time changes of the webpage 1216 on Person A's screen.

In some examples, when the Person A's device changes on the screen of Person A's device a current scroll X and Y position in the web browser window that is displaying the third-party webpage, the backend 101 receives the change and transmits code to the Person B's device to scroll the second web browser window displaying the third-party webpage to a same relative current scroll X and Y position.

In some examples, when the Person A's device changes a width and height of the web browser window that is displaying the third-party webpage, the backend 101 receives the change and transmits code to the Person B's device to change the web browser window displaying on the Person B's screen the third-party webpage to a same relative window width or window height of the first web browser window.

In some examples, the backend 101 is further configured for, when the Person A's device changes to a second third-party webpage 1216: receiving, from the front end 103 of the Person A's device, a web address of the second third-party webpage 1216; and sending code to the Person B's device webpage 1212 to display the second third-party webpage on the second web browser window with the second webpage view settings.

In some examples, when Person A changes the size of the webpage window, the Javascript™ codes of on the third part website, such as on the host server 1218, constantly refresh the webpage on Person B's device, for example at a predetermined frequency, such as every 2 seconds. In some examples, the shared webpage on Person B's device changes when scroll X and Y change on the webpage on Person A's screen.

In some examples, when the webpage 1216 on the Person A's device is changed to a second webpage in the web browser window of the Person A's device, the backend 101 is further configured to, subsequent to the detecting selection of the link by the Person B's device, receive, from the Person A's device, an address of the second webpage that is displayed on the web browser window of the Person A's device. The backend 101 may then transmit to the Person B's device code for displaying the second webpage in the web browser window with the second webpage view settings on the Person B's device. In some examples, the code further causes the Person B's device to output audibly the text or image of the third-party webpage 1212 on the Person B's device.

In some examples, when Person A starts browsing a new webpage, and if Person A would like to share the new webpage with Person B, the Person A may start process 1300 again.

In some other examples, after Person B clicks on the link, Person B may be routed to a first party web domain hosted or controlled by the BL 104, such as “musyfy.com/sender”, of which “musyfy.com” is an example first party web domain typically within or operated by the BL 104. The “/sender” is an extension of the domain name, and can be the name of Person A. The link can contain an address to the first party web domain. The webpage 121 is generated by the BL 104 and transmitted to Person B. The webpage 1212 mirrors the webpage 1216 Person A is viewing. The webpage 1212 has the contents from webpage 1210 hosted by host server 1218, and the webpage 1212 has the same window height and width as the webpage 1216 that Person A is browsing.

In some examples, the webpage 1212 on Person B may be a webpage 1212 generated by the BL 104 and inline framed to the webpage 1210 from third party host server 1218, so that the webpage 1210 can be displayed on the webpage 1212 of Person B. In other words, the part of the contents displayed from the webpage 1210, is inline framed using Hypertext Markup Language (HTML) “iframe” code and displayed on the webpage 1212 on the screen of Person B. In some other examples, the BL 104 caches the markup code (e.g. markup code containing text and images, such as HTML or XML) on the webpage 1210 and sends the markup code for display on the webpage 1212, to display a webpage 1212 on the screen of Person B. With the webpage 1212, Person B sees the same contents of the shared webpage 1216 from Person A. Commands or instructions are sent to the webpage 1212 of Person B so that the webpage 1212 has the same window height and width as the webpage 1216 that Person A is browsing.

In some examples, the BBL 1202 may retrieve from the host server 1218, via communication network 1205, information on the webpage 1210, including URL or webpage address, webpage width and height. In the example shown, the new webpage generated by the BL 104 has the URL: “musyfy.com/customer name”. The host server 1218 may be a third-party host server, wherein the third-party can be a retail e-commerce store.

In some examples, after Person B clicks on the link, screen sharing application 113 may provide an indication to show that Person B is connected with and follows Person A. The indication may be a visual indication such as a button on front end 103 turns to green, or an audio indication generated by ShoppingList application 113.

In some example, Person A and Person B may communicate with each other over voice via microphone during the webpage screen sharing process 1300. The BL 104 provides two-way audio communication between the devices of Person A and Person B.

In some example, during the webpage screen sharing process 1300, Person A and Person B may communicate with each other over live picture, video such as live video via cameras of Person A and B's devices, such as a Webcam of a computer or a camera of a mobile phone or a tablet. In some examples, live picture may include Picture in Picture during the screen sharing process. In an example, the Picture in Picture is an extension in the web browser application by way of a layer that is on top of the currently viewed webpage. In some examples, the profile pictures of the Person A and/or Person B may be displayed on the respective Person B and/or Person A's screens.

In some example, during the screen share process 1300, Person A and Person B may communicate with each other using voice via microphone as well as video via webcam or camera of Person A and Person B's devices.

During the webpage sharing process, Person A is connected with Person B by the system 100. For example, BL 104 communicates information between Person A and Person B. In some examples, when at least one of Person A and Person B leaves screen sharing application 113, such as by closing the shared webpage 1216 by Person A or closing the webpage 1212 on Person B's screen by Person B, the BBL 1202 terminates all of the connections, including audio or video communications, between the Person A and Person B. In some examples, the system 100 may notify one person, for example using message displayed on the person's screen, that the other person has left the ShoppingList application 113. In some examples, the backend 101 is further configured for terminating, by the backend 101, any changes to webpage 1212 on the Person B's device when the webpage 1216 is closed on the Person A's device.

In some examples (not shown), Person A may pause web screen sharing by clicking on a control button of ShoppingList application 113. In this case, each time when Person A scrolls the shared webpage 1216, the screen sharing application 113 will not update the scroll position on webpage 1212 of Person B.

In some examples (not shown), ShoppingList application 113 may allow Person A and Person B to swap web screen sharing roles of sender or leader and receiver or follower. In this case, Person B may share webpage screen of Person B with Person A using the process 1300 described herein.

In some examples, the backend 101 is configured for registering at least one website domain; wherein the front end 103 is embedded in each of at least one web browser window of the Person A's device, each web browser window associated with at least one of the website domains registered with the backend 101, wherein the backend 101 is configured to generate a unique device identification (ID) for uniquely identifying the Person A's device.

In the following scenario, the Person B's browser height and width settings and web browse window position are not modified, but only the scroll X and Scroll Y are updated to follow the Person A's view settings.

In some examples, the code of ShopplingList Application 113 is embedded in the third party website. Person A visits the third party website. Person A signs in the ShopplingList Application 113. The following information is sent from the Person A Frontend to the Backend.
a. Webpage domain address URL information,
b. Page Width,
c. Page Height,
d. Screen Width,
e. Screen Height,
f. Window Screen Top,
g. Window Screen Left,
h. Browser Name
i. Browser Settings,
j. Browser Window Width,
k. Browser Window Height,
l. Scroll X,
m. Scroll Y,
n. Device information,
o. Operating System information,
p. IP address,
q. Geo Coordinates, and
r. Time are sent to the Backend with a timestamp.

This information is saved in the Database 106. From this point onwards, any changes to the information captured above may be recorded with a timestamp. Person A can save items to a Shopping list for future buy. The Shopping List information is saved in the Backend database. Person A can add a new contact, if it's not there in the Contact List of the Browser Screen Share Application. Person A sends the invite, via a link, to the one or more Person B from the Contact list through email, phone message and/or Social Media Platform. By sending the invite, the Person A now becomes the Person A and the collected information in the information database is treated as Person A's information. The invite contains the link button and/or web page address to go to. Person B receives the invite. Person B clicks on the link from the invite, which opens a new tab of the browser or copy-paste the web address in the new tab of the Browser. The Person B's Screen Share Application communicates to the backend 101. The back end 101 authenticates the link from Person B. Once authenticated, the following information is sent from the Person B's ShoppingList Application 113 from Person B's front end 103 to the back end 101.
a. Person B's Screen Width,
b. Person B's Screen Height,
c. Person B's Browser Name
d. Person B's Browser Settings,
e. Person B's Window Width,
f. Person B's Window Height,
g. Person B's Window Screen Top,
h. Person B's Window Screen Left,
i. Person B's device information,
j. Person B's Operating System information
k. Person B's IP address
l. Person B's Geo Coordinates and
m. Time stamp.

The back end 101 sends the last saved Person A's Web page domain URL information to the Person B's front end 103. And the back end 101 notifies the Person A that the Person B has joined the social shopping. The Person B's front end 103 loads the Person A's URL Webpage and gets the Page width and Page Height information from the Hosting Server 1218. The back end 101 calculates the Scroll X and Scroll Y based on the information provided by the Person A and Person B. The back end 101 updates the Scroll X and Scroll Y position for the Person B's front end 103. Person B is taken to the new Scroll X and Y coordinates. At this point, Person B has the option to sign in to the Person B's Screen Share Application Front end 103.

In some examples, using, for example, iframe HTML code, the back end 101 prepares a First Party webpage with the Person A's URL webpage inline framed into the First Party Domain page (for example, musyfy.com/sender) for the Person B. The back end 101 sends the First Party Domain Address link to the Person B's front end 103. And the back end 101 notifies the Person A that the Person B has joined the Screen Share. The Person B's front end 103 loads the First Party Webpage (for example, musyfy.com/sender). The back end 101 calculates the Scroll X and Scroll Y based on the information provided by Person A and Person B. The back end 101 updates the Scroll X and Scroll Y position for the First Party Webpage on the Person B's front end 103. First Party Webpage is updated with the new Scroll X and Y coordinates.

In summary, the data may be collected during the screen sharing process are as follows:

Data Collected By the Backend and from where

| Person A Device | Person B Device | Third Party |
|---|---|---|
| a. Webpage domain address | | |
| URL info | | |
| OR Raster Image | | |
| b. Page Width, | | Page Width for Person A's |
| | | device Third Party URL |
| c. Page Height, | | Page Height for Person A's |
| | | device Third Party URL |
| d. Sender's Screen Width, | a. Receiver's Screen Width, | |
| e. Sender's Screen Height, | b. Receiver's Screen Height, | |
| f. Sender's Window Screen Top, | c. Receiver's Window Screen | |
| | Top, | |
| g. Sender's Window Screen Left, | d. Receiver's Window Screen | |
| | Left, | |
| h. Sender's Browser Name | e. Receiver's Browser Name | |
| i. Sender's Browser Settings, | f. Receiver's Browser | |
| | Settings, | |
| j. Sender's Browser Window | g. Receiver's Browser | |
| Width, | Window Width, | |
| k. Sender's Browser Window | h. Receiver's Browser | |
| Height, | Window Height, | |
| l. Scroll X, | | |
| m. Scroll Y, | | |
| n. Device information, | i. Receiver's device | |
| | information, | |
| o. Operating System information | j. Receiver's Operating | |
| | System info | |
| p. IPaddress | k. Receiver's IP address | |
| q. Geo Coordinates and | l. Receiver's Geo | |
| | Coordinates and | |
| r. Timestamp. | m. Time stamp. | |

In the some examples, the data transmitted from the backend 101 to the Person B's device may be summarized as follows:

Data Transmitted from the Backend to the Person B's device

| | | First Party webpage | |
|---|---|---|---|
| | | embodiment with | |
| | Third Party webpage | Sender's URL Link | First Party with Sender's |
| | embodiment | (“musyfy.com/sender”) | Raster Image |
| Mimics the Person | a. Webpage domain | a. iframe version of the | a. iframe version of the |
| A's web address | address URL info | URL | Raster Image |
| and scroll location | b. Page Width, | b. iframe version of the | |
| on the page on | | Page Width | |
| Person's B | c. Page Height, | c. iframe version of | |
| Browser (FIG. | | Page Height | |
| 12(a)) | d. Scroll X, | d. iframe version of | |
| | | Scroll X | |
| | e. Scroll Y, | e. iframe version of | |
| | | Scroll Y | |
| Mimics the size, | d. Sender's Window | f. Sender's Window | b. Sender's Window |
| position, and | Screen Top, | Screen Top, | Screen Top, |
| scroll location of | e. Sender's Window | g. Sender's Window | c. Sender's Window |
| the Person A's | Screen Left, | Screen Left, | Screen Left, |
| Browser on | g. Sender's Window | h. Sender's Window | d. Sender's Window |
| Person B's Screen | Width, | Width, | Width, |
| (FIG. 12(b) | h. Sender's Window | i. Sender's Window | e. Sender's Window |
| | Height, | Height, | Height, |

Therefore, ShoppingList application 113 allows Person A to share webpage with Person B by only sharing the selected information with Person B, such as the URL or web address, screen settings, webpage view settings, browser settings and Scroll X and Y position of Person A's device and screen settings and Browser settings of Person B.

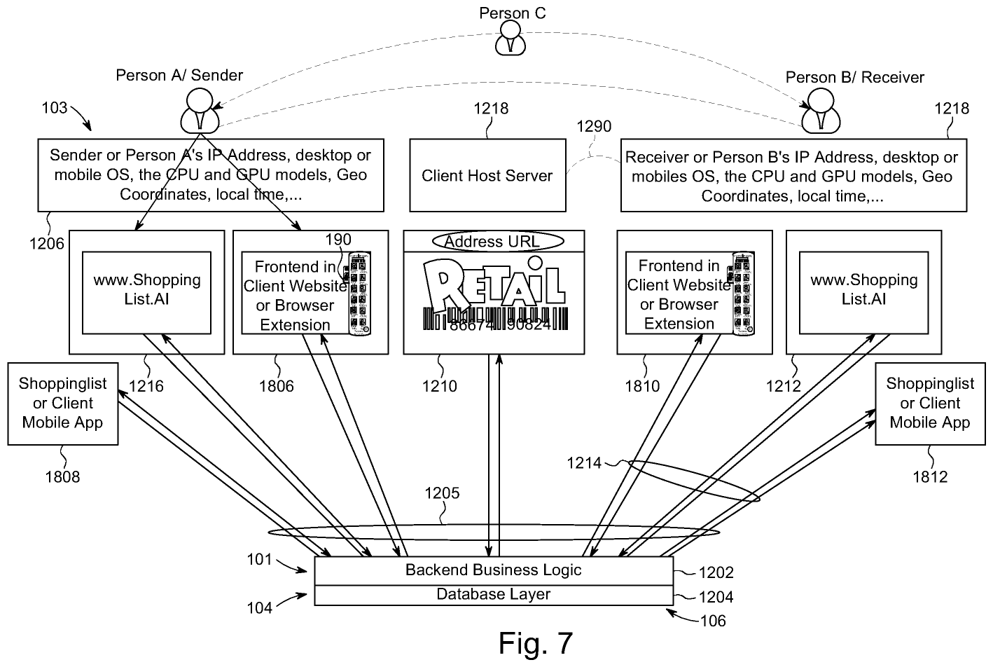

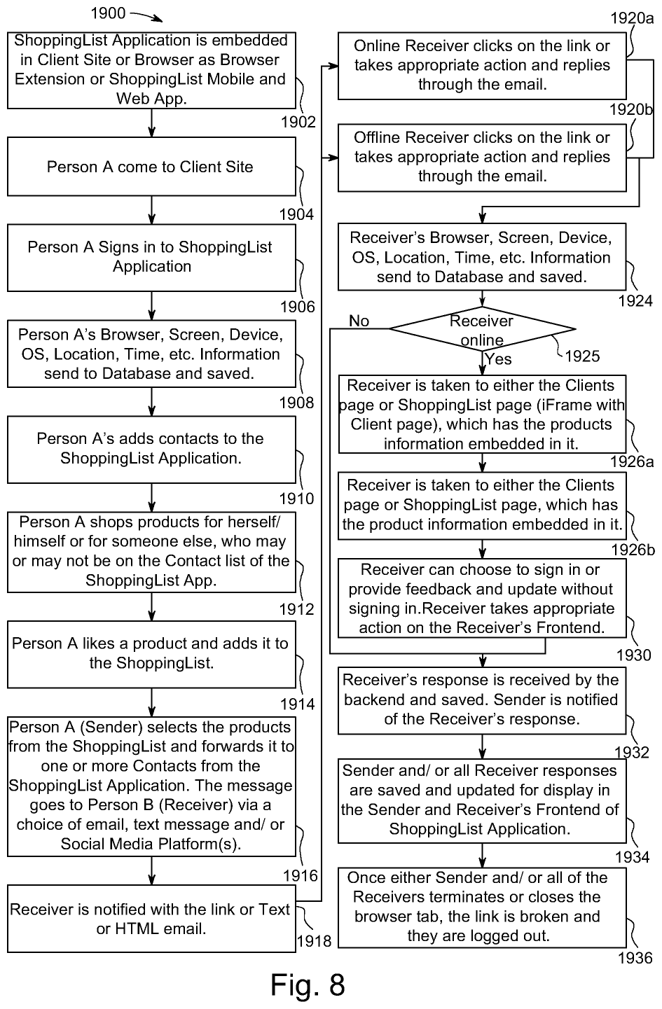

Secure social online shopping will now be described, in accordance with example embodiments in FIGS. 7 and 8. FIG. 7 is an example of the web screen sharing systems described in FIGS. 5(a) and 5(b) that may be used in the ShoppingList Application 113 in peer assisted electronic commerce, such as social online shopping, according to an embodiment. The screen sharing system in FIG. 7 works the same way in screen sharing between Person A and Person B as described in FIGS. 5(a) and 5(b). FIG. 8 is a flow chart showing an exemplary process using the screen sharing system of FIG. 7 for social shopping.

As described above, the ShoppingList application 113 may be embedded in a webpage embedded with the front end 103 of system 100 or at least one web browser window as browser extension embedded with the front end 103 of system 100. The ShoppingList applications 113 as the front end 103 may be accessed from a web application, a mobile application, a client website, or embedded in the browser as browser extension.

In the example illustrated in FIG. 7, ShoppingList applications 113 may be embedded in a dedicated website, such as www.shoppinglist.AI. The dedicated website may maintain information of customers subscribed to the services of ShoppingList application 113, such as consumer profiles, list of contacts of each consumer, recent and past shopping lists of each consumer, and the products in each shopping list. In the example of FIG. 7, the subscribed customers may include Person A and Person B. Person A may access to the dedicated website via the webpage 1216, and Person B may access to dedicated website via the webpage 1212.

The ShoppingList applications 113 may also be embedded in an online business website, which may be hosted in the client host server 1218. The online business may be an online retailer. When a consumer, such as Person A, visits the website of the online business, the webpage 1806 may be used to provide services of ShoppingList application 113. In the example of FIG. 7, Person B may also visit the website of the online business with the webpage 1810 to access ShoppingList application 113.

The ShoppingList applications 113 may also be installed and used in a Person A's device 1206 or Person B's device 1208. Person A's device 1206 and Person B's device 1208 may be a mobile device. In the example of FIG. 7, Person A's device 1206 may include a ShoppingList or client mobile application 1808, and Person A's device 1206 may include a ShoppingList or client mobile application 1812. Person A's device 1206 and Person B's device 1208 may also include other software for transmitting and receiving messages, including Ecommerce Retailer Mobile applications, messaging applications, and/or social media applications such as WhatsApp.

In the example of FIG. 7, Person A or Person B may access the ShoppingList applications 113 via any one of the three mechanisms described above.

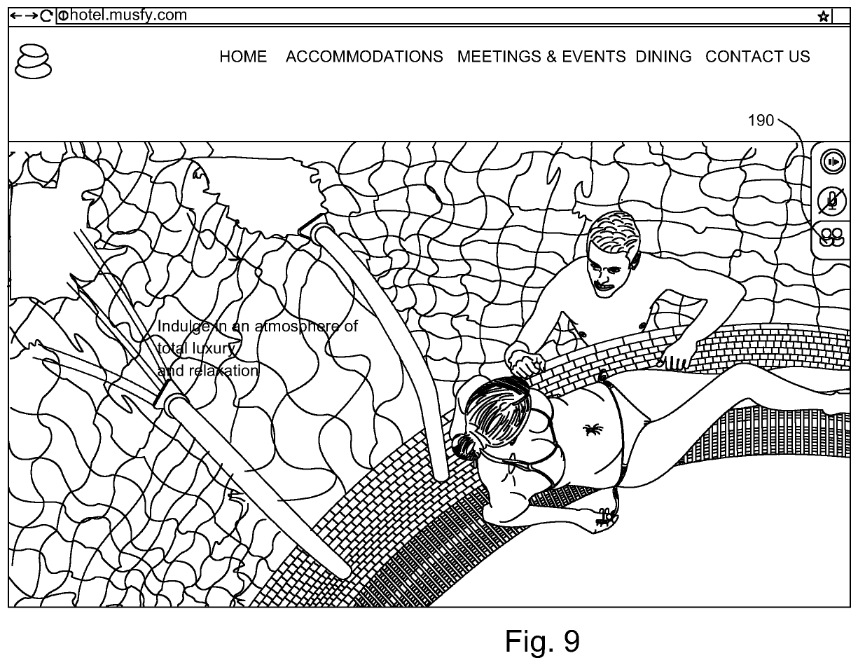

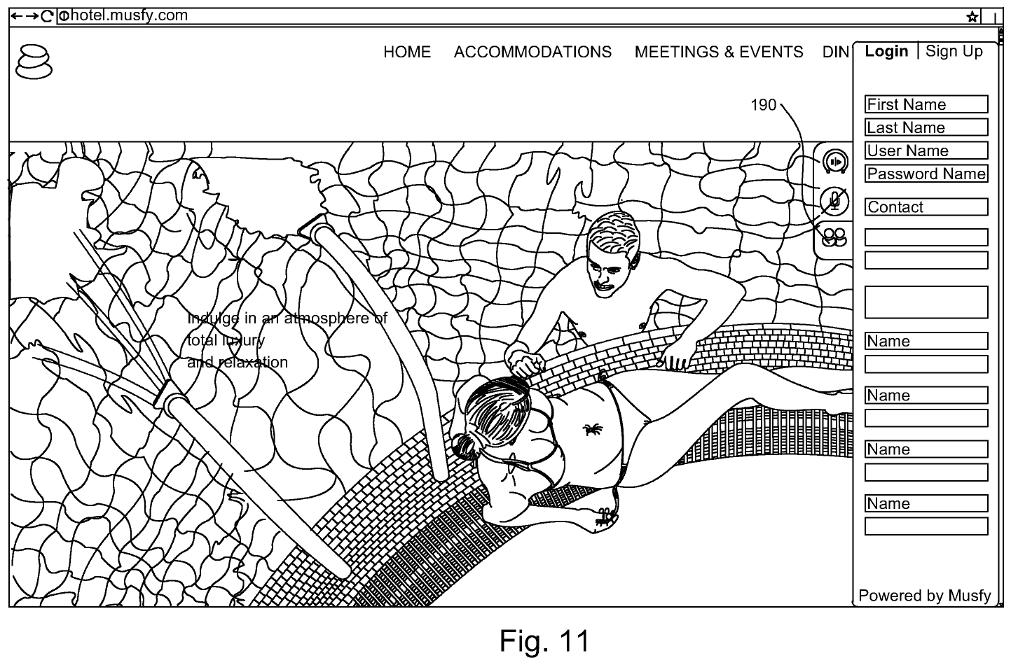

FIGS. 9-16 are examples of webpages in which the ShoppingList Application 113 is embedded. The ShoppingList application 113 may also be a mobile or web application for a mobile device 1808 or 1812. (Step 1902). For example, the mobile device may be a smart phone, a laptop or a tablet.

After the ShoppingList application 113 is installed in a web browser, the ShoppingList applications 113 may be associated with a specific person or client, including an online business, for example, associated with the web page of an online business.

Person A may visit a website of an online business at webpage 1210 (Step 1904)). When browsing the web page 1210, Person A may initiate the ShoppingList application 113 at the front end 103, for example, by opening the webpage 1216 embedded with the ShoppingList application 113, for example, the webpage at the URL www.shoppinglist.ai. Person A may also initiate the ShoppingList application 113 by clicking on a control button on the front end 103 of the client website, or in the browser extension to open a web page 1806.

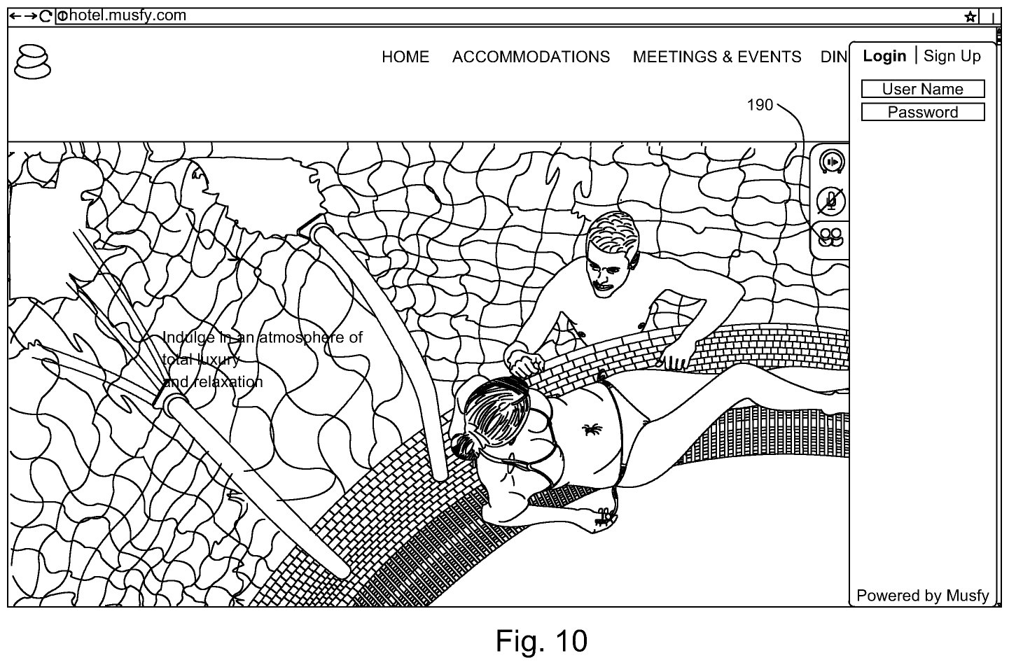

The BL 104 may require Person A to log into the system 100 at 1804. As illustrate in FIG. 10, Person A may provide login credentials to sign in to the ShoppingList Application (Step 1906). After BL 104 has verified the login credentials of Person A, Person A may access ShoppingList application 113. If Person A has not subscribed to the services with the system 100, the Person A may sign up providing the necessary information to identify Person A in the system 100, as illustrated in the example of FIG. 10. The process of signing up with system 100 is same as the process described above in FIG. 3. In some examples, if Person A has logged into system 100 once, all of the subscribed services are available to Person A.

After Person A logs in system 100 and starts ShoppingList application 113, the front end 103 may collect information of Person A and communicate, via a communication network 1205 such as the Internet, with the BL 104. In this example, Person A is browsing a third party webpage 1210 of a third-party host server 1218. The third-party webpage 1210 is loaded with the front end 103 or browser extension and is registered with the BL 104. In the examples of FIG. 7, the front end 103 collects and sends to Backend Business Logic (BBL) 1202 at the backend 101 webpage information related to Person A via the communication network 1205, such as current Uniform Resource Locator (URL) of the webpage 1210, screen width and height of Person A's device 1206, the window width and height of the web browser window, the web browser window position (Window Screen Top, Window Screen Left) on the screen of Person A, the webpage width and height of the webpage 1216, and the coordinate of the scroll X and Y. In some examples, webpage information related to Person A that the front end 103 collects and sends to Backend Business Logic (BBL) 1202 includes the locations of the web browser window position on the screen of Person A 1216 (Window Screen Top, Window Screen Left). In some example, the front end 103 may also collect and send additional information of Person A including IP address, the operation system of the Person A's device, such as a desktop or a mobile device, the models of the Central Processing Unit (CPU) or Graphics Processing Unit (GPU) used in the Person A's device, geographical coordinates and local time of Person A, and browser name and settings of Person A's device 1206 to BBL 1202 through Communication network 1205. The front end 103 may send BBL 1202 the URL of the webpage 1210 Person A is browsing, the dimensions of the webpage 1216 of Person A, the screen width and height of Person A 1206, the Window Width and Height of Person A 1216, the web browser window position (Window Screen Top, Window Screen Left) on the screen of Person A, and the relative position of the contents of the webpage 1216 of Person A is browsing based on the position of scroll X and Y. he BL 104 in the example of FIG. 7 includes the Backend Business Logic (BBL) 1202, Database Layer (DL) 120. In some examples, the DL 1204 may include database abstraction (DA) 408, and database 106. The DL 1204 may save the received information of Person A to the database 106 (Step 1908).

As described in FIGS. 5(a) and 5(b), the information of Person A communicated to the BL 104 may be used by the ShoppingList Application 113 to share the web screen with the Person B. As well, the information may be used for cross validating Person A, even before Person A has signed in to the system 100, for example, by using the link and/or Person A's device information, IP Address and Browser Settings to uniquely identify Person A and Person A's device.

Person A may add contacts on the device 1206 to the ShoppingList Application 113 (Step 1910). For example, the contacts of Person A may be saved to the database 106. As illustrated in FIG. 12, the contacts of Person A in the ShoppingList Application 113 may be form the social circle favorites of Person A, including friends and family members. As illustrated in the example of FIG. 12, after the social shopping button 190 of the ShoppingList Application 113 is clicked, an interface containing a favorites tab and a Shopping list tab is displayed. If the favorites tab is selected, an exemplary list of favorite contacts for person A to contact may be displayed on the front end 103. The ShoppingList Application 113 may include the function of using microphone. The status of the microphone may be switched among “Off”, “On”, and “Mute” when the microphone button is clicked. If the microphone is on the “ON” status, person A may speak with other persons listed on the favorite contacts from the front end 103. After the social shopping button 190 is clicked, an exemplary list of products, such as shoes, jewelry, hand bags, etc., or web pages that have been added previously in the ShoppingList Application 113, for example in a tabular format. Accordingly, the ShoppingList Application 113 or the system 100 may keep and maintain the contact list of Person A.

Person A may shop products on the webpage 1210 for Person A, or for others, such as for Person B, Person C, or Person B and Person C (Step 1912). When Person A shops for other person(s), who may or may not be on the contact list on the ShoppingList Application 113. If the other person(s) is not on the contact list of Person A on the ShoppingList Application 113, Person A may add the person's information to ShoppingList Application 113.

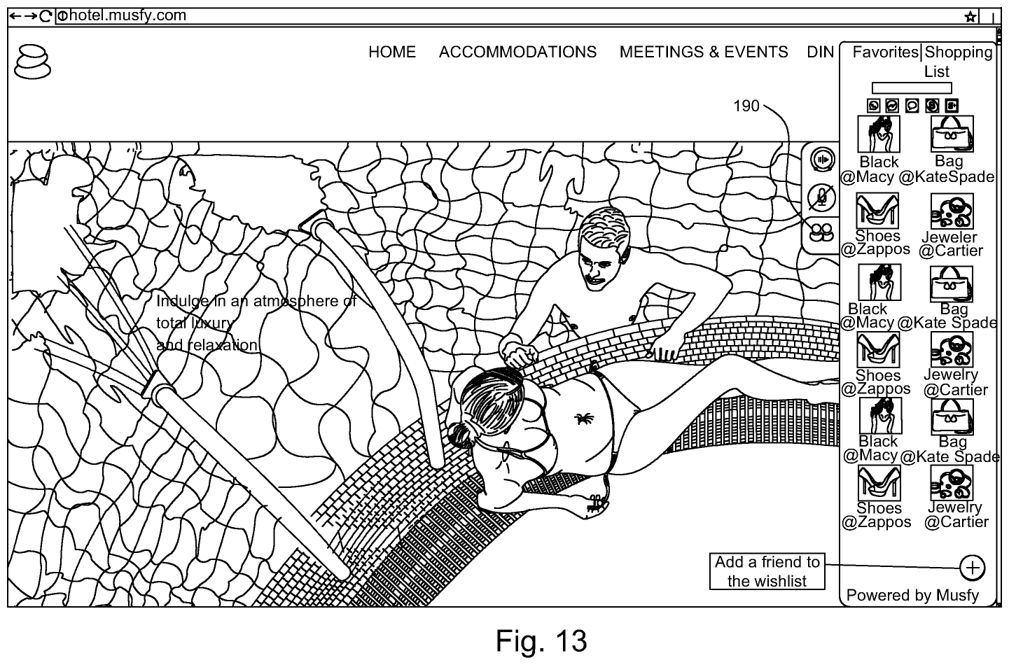

If Person A likes a product and, he or she may add it to a shopping list provided by the ShoppingList Application 113 (Step 1914). An example of the shopping list is illustrated in FIG. 13. In some examples, BBL 1202 may save the product added to the ShoppingList Application 113 in the DL 1204, such as in database 106. As such, the ShoppingList Application 113 or the system 100 allows Person A to keep and maintain his or her shopping list. Each product on the ShoppingList Application 113 may link to a specific webpage of an online business.

Person A may select a product from the Shopping List and forward it to one or more contacts, such as Person B, or Person B and Person C, from the ShoppingList Application 113 (Step 1916). The product may be selected for Person A, for Person B or C, or for Person B and C. Person A may invites Person B to respond to the selection of the product, such as for feedbacks on the product via email, phone text message, and/or a social media platform, for example, Facebook™, WhatsApp™, Windows Live Messenger™, Skype™, Google Plus™, etc. Person B may represent one or more people. Person A may send an invitation or notification to Person B and/or Person C. For example, the invitation can be in the form of an email, a text message, or an invitation from the social medial platform, each containing a web link for directing the Person B to the system 100 and to the product information. For example, the front end 103 may send the invitation to the account of Person B in the selected social media platform, such as WhatsApp™, Facebook™, Windows Live Messenger™, Skype™, Google Plus™, etc. In some examples, when Person A signs into the front end 103 of system 100, Person A may sign into one or more various Social Media platforms that are associated with Person A. In some examples, in addition to the web link, the ShopplingList application 113 may also send a personalized or customized message to Person B, such as a voice message of Person A. In the example of FIG. 14, the Person A may send one or more messages to the two or more people to solicit feedbacks on a selected product.

Person A may send the messages to Person B and/or Person C via the BBL 1202 and DL 1204. In the example of FIG. 7, Person B is available by responding to the message within a predetermined period, for example, 30 minutes. Person C is unavailable by not responding to the message within the predetermined period. Person C may respond to the message at a later time.

The BL 104 may notify Person B, the receiver, the invitation and the web link in a message, which may include an email, such as an HTML email, or a text message (Step 1918). In some examples, the message may include a form for the recipient to filling the requested information, such as feedbacks on a product. In some examples, the social media platform is used to communicate other modalities for the Person B to further communicate with Person A. For example, Person A may send to Person B, via social media platform, a phone number, or a web link in an email, or a tweet message using Twitter™ for Person B to reach the designated webpage having the web screen share session initiated by Person A. In other examples, the BL 104 may directly send the invitation or notification to Person B.

In the process 1900, Person B may represent one or more people. Person B may be friends or family members of Person A. At step 1920a, if Person B is online and available to respond to the message, Person B may click on the web link contained in the invitation to access to the product information. At step 1920b, if Person B is offline or not available to respond to the message, Person B may take appropriate actions, for example, Person B may reply the email, or the text message with Person B's feedbacks or response, including comments and ratings of the product.

Person B may be online or offline when Person B receives the message. If Person B is online, or after Person B becomes online from offline, after Person B has clicked on the web link contained in the invitation, Person B opens a webpage. In the example of FIG. 7, the webpage may be webpage 1212 from the dedicated website, or webpage 1810 from the online business, or a webpage 1812 from a mobile device. Person B's device 1208 may send to BBL 1202 additional information related to the Person B's webpage 1212 via the communication network 1205, including Browser Settings, the IP address, the operation system, device such as a desktop or a mobile device, the models of the Central Processing Unit (CPU) or Graphics Processing Unit (GPU) used in the device 1208, location including geographical coordinates, and local time of Person B (Step 1924). In some examples, the additional information may be used for determining and displaying the new X and Y coordinates of the webpage for Person B, based on the devices used by Person A and Person B. For example, Person A may use a computer while Person B may use a Mobile phone. The information of the shared webpage may be displayed on the Person B's device according to the device used by Person B so that webpages displayed on the devices of Person A and Person B have the same contents. In other examples, the additional information may be used for cross validating a customer, such as Person B, even before the customer has signed in to the system 100, for example, by using the link and/or Person B's device information, IP Address and Browser Settings to uniquely identify Person B and Person B's device. BBL 1202 may save the received information from the front end 103 of Person B in the DL 1204, such as in database 106. This information of Person B may be used to determine the Device ID, in some examples, for unique identification of Person B. As described in FIGS. 5(a) and 5(b), the web page screens of Person B and/or Person A may be adjusted based on this additional information related to the Person B's webpage 1212.

At step 1925, if the Person B is not offline and unavailable, the process 1900 proceeds to step 1932 to be described below.

At step 1925, if Person B is online and after Person B has clicked on the web link contained in the message, the web link may direct Person B to a designated webpage, which may include the client web page 1210 associated with the web link, the webpage 1810 embedded with the ShoppingList application 113, or the ShoppingList page 1212 which is inline framed with the client page 1210 using Hypertext Markup Language (HTML) “iframe” code and displayed on the webpage 1212 on the screen of Person B, or the webpage 1812 when the Person B's device 1208 is mobile device embedded with the ShoppingList application 113 as a web or mobile application. The designated webpage may be displayed in two different ways. For example, at step 1926a, the designated webpage is displayed on the screen of Person B with ShoppingList page 1212 inline framed with the client page 1210 using Hypertext Markup Language (HTML) “iframe” code. At step 1926b, the designated webpage is displayed on the screen of Person B with the product summary information with the Hyperlink to the client web page 1210 or to the ShoppingList page 1212 without iFrame option. In the example of FIG. 7, the webpage 1212 may display contents of the webpage 1218 based on updated scroll X and Y positions 1290 on the webpage 1212 with the URL and the screen and browser information of Person B The designated webpage includes the information of the product selected by Person A (step 1926).

After the Person B is on the designated webpage, Person B may sign in to the ShoppingList application 113 to directly communicate with Person A, to provide feedbacks with respect to the product via the ShoppingList application 113. In some examples, as Person B has been identified by the system 100 with the information provided at step 1924, Person B may take appropriate action by providing feedbacks on the product and updating on the designated web page via the ShoppingList application 113 without actually signing into the ShoppingList application 113. (Step 1930).

FIG. 15 illustrates an example of feedbacks and rating received from Person B with respect to one or more products for which feedbacks are requested by Person A. In some examples, Person B is able to provide the feedback and rating as Person B has already bought or used the products. In some examples, Person B is the person for whom Person A would like to purchase the product. In some examples, the product may also be purchased for a common person in the social circle of Person A and Person B. In some examples, the system 100 may notify Person A about the feedbacks from Person B and/or Person C.

The front end of the ShopplingList application 113 of Person B may send Person B's response to the back end 101 of system 100. BBL 1202 may save the received response from the front end of the ShopplingList application 1803 in the DL 1204, such as in database 106. The back end 101 may notify Person A the response from Person B, which include the comments, feedback, and rating of a product, from the Person B (Step 1932). In some examples, the back end 101 may display the response from Person B on the front end of Person A, or send a text message or an email to Person A.

At step 1932, if the Person B is offline, the Person B's feedbacks may be received at the corresponding ShoppingList application 111 at the backend 101, and the ShoppingList application 111 may process the feedbacks and responses, for example, by tabulating the feedbacks and responses, and send the processed feedbacks and responses to the ShoppingList application 113, among feedbacks or responses from others, at the front end 103 of the system 100. In some examples, the Person A may make a purchase decision based on the response or reply message from Person B.

Person B's response may be displayed on the front end of the ShoppingList application 113 of the Person A. Person A may generate further response in view of Person B's response at the front end of the ShopplingList application 113 of Person A.

The front end of the ShopplingList application 113 may send Person A's response to the back end 101 of system 100. BBL 1202 may save the Person A's response in the DL 1204, such as in database 106. The back end 101 of system 100 may also send the Person A's response to the front end of the ShopplingList application 1803 of Person B for display (Step 1934).

The web link is broken if either Person A or Person B terminates or closes the web browser window or tab, and the ShoppingList applications 113 log respective Person A and Person B out (step 1936). In some examples, the back end 101 may display or output a message to one person that the other person has terminated the session.

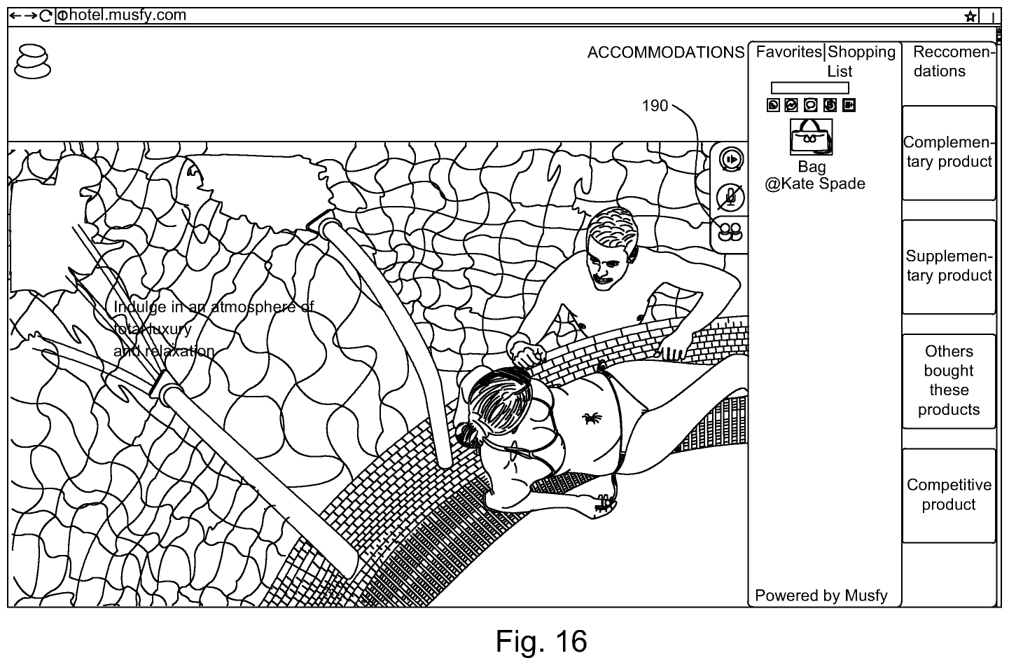

As well, the back end 101 of system 100 may allow an online business to provide additional product offering based on the product selected by Person A via the ShoppingList application 113. In the example of FIG. 16, the back end 101 of system 100 may, via the ShopplingList application 113, provide recommendations to Person A, and/or Person B with respect to the product, including other relevant information of the product, such as the complementary products information, supplementary products, other customers inside or outside the social circle of the Person A who have bought the product, and information of relevant competing products. Person A may make informed purchase decision in view of the recommendations from Person B. As such, Person A can adequately consider the response from the Person B, such as feedbacks, rating and recommendations of a product from the Person A's social circles, including friends and family members, before Person A makes a purchase decision of the product. With the feedbacks, rating, and recommendations from Person B, System 100 offers to Person A the choice to ascertain the product-potential customer fit before the product is purchase by Person A.

By using the ShoppingList Application 113 of system 100, the sales of online businesses may be improved, as Person B may also purchase or influence other to purchase the same product due to the social shopping experience with Person A. As well, by using the ShoppingList Application 113 of system 100, Person A may purchase a product for Person B and/or Person C after receiving the feedbacks, ratings or recommendations from Person B and/or C, or receiving the consent or endorsement from the Person B or C. In some examples, based on the feedbacks, ratings or recommendations from Person B and/or C, Person B and C may purchase the product for Person A. In some examples, based on the responses, feedbacks, ratings or recommendations from Person B and/or C, Person A, B and/or C may purchase the product for a third person who may be a friend or family member of at least one of Person A, B, and C. In some examples, Person A and Person B may discuss a product via the ShoppingList Application 113, if both Person A and Person B feel that the product fits into their needs, they may collectively purchase the product, and split the costs.

Therefore, the ShoppingList Application 113 of system 100 offers a platform to solicit the personalized and customized product fit with respect to the potential consumer, such as Person A, Person B and Person C, before the product is bought. With the ShoppingList Application 113 of system 100, the product-potential customer fit can be determined before the product is purchased. Therefore, the ShoppingList Application 113 of system 100 offers lower total cost of the product by reducing product returns and this also improves customer goodwill. The system 100 may also aggregate demand from not only the potential consumer, such as Person A, Person B or Person C, but also from the social circles of the potential consumer, and therefore may increase the sales of online business and conversion rates of consumers.

As well, in some examples, Person A and Person B may both purchase the same product after Person B has provided the feedbacks, ratings to the product. System 100 has each of Person A and Person B's contact information by virtue of the sign up with the system 100 or by the contact information provided by Person A. Therefore, the system 100 may assign, ship and bill the purchased products to multiple parties, such as Person A and Person B, from the same order by recording, shipping and assigning the purchased product to different parties. In some examples, the system 100 may also divide and bill multiple parties from the same order.

In some examples, the ShoppingList applications 113 may have API plugin for e-commerce platforms, such as WordPress, Magento and Shopify.

In accordance with an example embodiment, there is provided a non-transitory computer-readable medium containing instructions executable by a processor for performing any one of or all of the described methods. In accordance with an example embodiment, there is provided a processor-implemented method for performing any one of or all of the described functions described with respect to any of the processors.

In the described methods, the boxes may represent events, steps, functions, processes, modules, state-based operations, etc. While some of the above examples have been described as occurring in a particular order, it will be appreciated by persons skilled in the art that some of the steps or processes may be performed in a different order provided that the result of the changed order of any given step will not prevent or impair the occurrence of subsequent steps. Furthermore, some of the messages or steps described above may be removed or combined in other embodiments, and some of the messages or steps described above may be separated into a number of sub-messages or sub-steps in other embodiments. Even further, some or all of the steps may be repeated, as necessary. Elements described as methods or steps similarly apply to systems or subcomponents, and vice-versa. Reference to such words as “sending” or “receiving” could be interchanged depending on the perspective of the particular device.

While some example embodiments have been described, at least in part, in terms of methods, a person of ordinary skill in the art will understand that some example embodiments are also directed to the various components for performing at least some of the aspects and features of the described processes, be it by way of hardware components, software or any combination of the two, or in any other manner. Moreover, some example embodiments are also directed to a pre-recorded storage device or other similar computer-readable medium including program instructions stored thereon for performing the processes described herein. The computer-readable medium includes any non-transient storage medium, such as RAM, ROM, flash memory, compact discs, USB sticks, DVDs, HD-DVDs, or any other such computer-readable memory devices.

It will be understood that the devices described herein include one or more processors and associated memory. The memory may include one or more application program, modules, or other programming constructs containing computer-executable instructions that, when executed by the one or more processors, implement the methods or processes described herein.

The various embodiments presented above are merely examples and are in no way meant to limit the scope of this disclosure. Variations of the innovations described herein will be apparent to persons of ordinary skill in the art, such variations being within the intended scope of the present disclosure. In particular, features from one or more of the above-described embodiments may be selected to create alternative embodiments comprises of a sub-combination of features which may not be explicitly described above. In addition, features from one or more of the above-described embodiments may be selected and combined to create alternative embodiments comprised of a combination of features which may not be explicitly described above. Features suitable for such combinations and sub-combinations would be readily apparent to persons skilled in the art upon review of the present disclosure as a whole. The subject matter described herein intends to cover all suitable changes in technology.

Certain adaptations and modifications of the described embodiments can be made. Therefore, the above discussed embodiments are considered to be illustrative and not restrictive.

What is claimed is:

1. A system for social shopping, the system comprising:
a backend configured for:
receiving, from a front end within a first web browser application of a first device, a selection of a product from a third-party webpage originated from a third-party host server;
generating, at the backend, a message with respect to the product;
sending, from the back end, the message to a second device;
receiving, from the second device, a response to the message; and
transmitting the response from the second device to the front end for displaying and enabling a person to make a purchase decision with respect to the product.

2. The system of claim 1, wherein the backend is further configured for:
receiving, from the front end, an address of the third-party webpage;
receiving, from the third party host server, the web page width and height of the third party webpage;
generating a link that addresses the backend;
sending the link to the second device.

3. The system of claim 1, wherein the backend is further configured for:
generating, using an inline frame function, a first party webpage with the third-party webpage from the third-party host server inline framed within the first party webpage; and
generating a link that addresses the backend;
wherein the link include an address to the first party webpage; and
wherein the code that is transmitted from the backend to the second device includes the first party webpage, for the displaying of the third-party webpage, inline framed within the first party webpage and having the second scroll X and Y positions, on the second web browser window of the second device.

4. The system of claim 2, wherein the backend is further configured for:
receiving, from the front end, screen width and height of the first device;
receiving, from the front end, first webpage view settings of the first web browser window that is displaying the third-party webpage, the first webpage view settings comprising width and height of the first web browser window that is displaying the third-party webpage, and first scroll X and Y positions of the first web browser window that is displaying the third-party webpage;
in response to detecting selection of the link by the second device:
receiving, from the second device, second screen width and height of the second device, and width and height of the second web browser window, and
transmitting, to the second device, code for displaying of the third-party webpage on a second web browser window of the second device, and second webpage view settings, comprising second scroll X and Y positions of the second web browser window, for displaying of the third-party webpage on the second web browser window of the second device to effect a same relative webpage view setting as the first webpage view settings of the first web browser window that is displaying the third-party webpage on the first device.

5. The system of claim 4, wherein the same relative webpage view setting is determined by the backend by calculating a proportion of the width and height of the first web browser window to the screen width and height of the first device, and determining a same proportion of the second width and height of the second web browser window to the second screen width and height of the second device.

6. The system of claim 2, wherein when the first webpage view settings of the first web browser window that is displaying the third-party webpage third-party are changed in the first device, the backend is further configured to receive, from the front end, subsequent to the detecting selection of the link by the second device, updated first webpage view settings of the third-party webpage displayed on the first device; and transmit, to the second device, updated second webpage view settings to effect the same relative webpage view setting as the updated first webpage view settings received from the front end of the first device.

7. The system of claim 2, wherein the backend is further configured for receiving, from the front end, additional information comprising at least one of: browser name and browser settings on the first device, IP address, operation system of the first device, models of the Central Processing Unit (CPU) or Graphics Processing Unit (GPU) of the first device, geographical coordinates, or local time of the first device; and
wherein the backend is further configured for uniquely identifying the first device based on at least one of the additional information before the first device logs into the system.

8. The system of claim 2, wherein the backend is further configured for receiving, from the second device, additional information comprising at least one of: browser name and browser settings on the second device, IP address, operation system of the second device, models of the Central Processing Unit (CPU) or Graphics Processing Unit (GPU) of the second device, geographical coordinates, or local time of the second device; and
wherein the backend is further configured for uniquely identifying the second device based on at least one of the additional information of the second device to uniquely identify the second device before the second device logs into the system.

9. The system of claim 1, further comprising prior to sending the message to the second device, receiving, from the front end, contact information associated with the person.

10. The system of claim 9, the contact information comprises social circle favorites of the person.

11. The system of claim 9, the backend further configured for keeping and maintaining a contact list of the person.

12. The system of claim 1, wherein the product is selected for one or more people.

13. The system of claim 1, the backend further configured to maintaining a shopping list for the person.

14. The system of claim 13, wherein each product on the shopping list is linked to a specific webpage of an online business.

15. The system of claim 1, wherein the backend sends the message to the second device via at least one of an email, a text message, and/or a social media platform.

16. The system of claim 1, the backend further configured for notifying the second person the message with an email or a text message.

17. The system of claim 1, wherein the response comprises feedbacks and ratings of the product.

18. The system of claim 1, wherein the backend receives the response from a second front end of the second device.

19. The system of claim 1, the backend further configured for notifying the first device the response from the second device by displaying the response on the front end, or sending a text message or an email to the first device.

20. The system of claim 1, the backend further configured for providing additional product offering based on the product selected by the person, wherein the additional product offering comprising complementary products information, supplementary product information, customers inside or outside a social circle of the first who have bought the product, and information of relevant competing products.
